(19) United States
(12) Patent Application Publication
(10) Pub. No.: US 2022/0006641 A1
(43) Pub. Date: Jan. 6, 2022

(54) Distribution of Blockchain Validation

(71) Applicant: Inveniam Capital Partners, Inc., New York, NY (US)

(72) Inventor: Paul Snow, Austin, TX (US)

(73) Assignee: Inveniam Capital Partners, Inc., New York, NY (US)

(21) Appl. No.: 17/365,951

(22) Filed: Jul. 1, 2021

Related U.S. Application Data
(60) Provisional application No. 63/047,936, filed on Jul. 3, 2020.
(60) Provisional application No. 63/061,372, filed on Aug. 5, 2020.

(51) Int. Cl. H04L 9/32; H04L 9/08

(52) U.S. Cl. CPC H04L 9/3239; H04L 2209/08; H04L 9/0869

(57) ABSTRACT

A blockchain environment may accumulate Merkle values calculated by individual nodal machines. Any nodal machine (such as a miner system) need only be sent Merkle child values as inputs. The nodal machine may then determine a hierarchical Merkle value based only on the Merkle child values provided as the inputs. Because the nodal machine only requires the Merkle child values, the nodal machine is relieved from downloading/storing an entire blockchain. The nodal machine need only download the piece, segment, or portion of interest, which consumes far less memory byte space and requires far less processor time/tasks/cycles/operations. Moreover, because each nodal machine only needs to download a small block/byte portion of the blockchain, network packet traffic is greatly reduced.

### CROSS-REFERENCE TO RELATED APPLICATIONS

This patent application claims domestic benefit of U.S. Provisional Application No. 63/047,936 filed Jul. 3, 2020 and incorporated herein by reference in its entirety. This patent application also claims domestic benefit of U.S. Provisional Application No. 63/061,372 filed Aug. 5, 2020 and incorporated herein by reference in its entirety.

### BACKGROUND

Today's blockchain processing consumes great hardware, network, and energy resources. When Satoshi first proposed a cryptographic blockchain, so-called “miners” expended CPU time and electricity to mine blockchain data. The mining of blockchains was democratic, meaning anyone with a conventional CPU-based computer could process the complicated calculations required to embed a block of data on a blockchain. Soon, though, the miners realized that a graphics processing unit (or GPU) was much faster than a CPU and could be optimized to solve the complicated calculations. Soon thereafter, most or all blockchain mining was performed by a specially programmed GPU computer, as a conventional CPU-based computer was comparatively too slow. Today, though, the miners use a specially-designed application-specific integrated circuit (or ASIC), as ASICs are even faster than GPUs. These ASIC computers are much faster at solving the complicated calculations, but the ASIC computers are very expensive and consume large amounts of electrical power. The ASIC computers are so cost prohibitive that, today, blockchain mining is largely undemocratic. Only a relatively small number of miners have access to the financial capital and to energy sources to mine blockchains. Moreover, as blockchain verification becomes more and more complex, even ASIC computers may lack adequate processing and memory resources.

### SUMMARY

Exemplary embodiments encourage blockchain miners to use CPU-based computer machines. Exemplary embodiments discourage or deter the use of specialized hardware (such as GPUs and ASICs) in blockchain mining by dispersing blockchain encryption and validation amongst multiple blockchain nodal computers. That is, a blockchain environment may utilize accumulator devices that collect nodal Merkle values calculated by individual miners and other nodal machines. Any nodal machine (such as a miner system) need only retrive Merkle child values as inputs. The nodal machine may then determine a hierarchical Merkle value based only on the Merkle child values provided as the inputs. Because the nodal machine only requires the Merkle child values, the nodal machine is relieved from downloading/storing an entire blockchain. The nodal machine need only download the piece, segment, or portion of interest, which consumes far less memory byte space and requires far less processor time/tasks/cycles/operations. GPUs, ASICs, and other specialized processing hardware components are thus deterred and unnecessary.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-11 illustrate distributed validation in a blockchain environment 20, according to exemplary embodiments;

FIGS. 12-20 illustrate additional distributed processing, according to exemplary embodiments;

FIGS. 21-24 illustrate randomization, according to exemplary embodiments;

FIG. 25 illustrates RAM binding, according to exemplary embodiments;

FIG. 26 illustrates vendor processing, according to exemplary embodiments;

FIGS. 27-28 illustrate democratic mining, according to exemplary embodiments;

FIG. 29 is a more detailed illustrations of an operating environment, according to exemplary embodiments;

FIGS. 30-31 illustrate validation specifications, according to exemplary embodiments;

FIG. 32 illustrates remote retrieval, according to exemplary embodiments;

FIGS. 33-34 illustrate a bit shuffle operation, according to exemplary embodiments;

FIGS. 35-36 illustrate database sizing, according to exemplary embodiments;

FIGS. 37-40 illustrate a table identifier mechanism, according to exemplary embodiments;

FIG. 41 illustrates agnostic blockchain mining, according to exemplary embodiments

FIGS. 42-43 illustrate virtual blockchain mining, according to exemplary embodiments;

FIG. 44 further illustrates validation monitoring, according to exemplary embodiments;

FIG. 45 is a flowchart illustrating a method or algorithm for mining blockchain transactions, according to exemplary embodiments; and

FIG. 46 depicts still more operating environments for additional aspects of exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

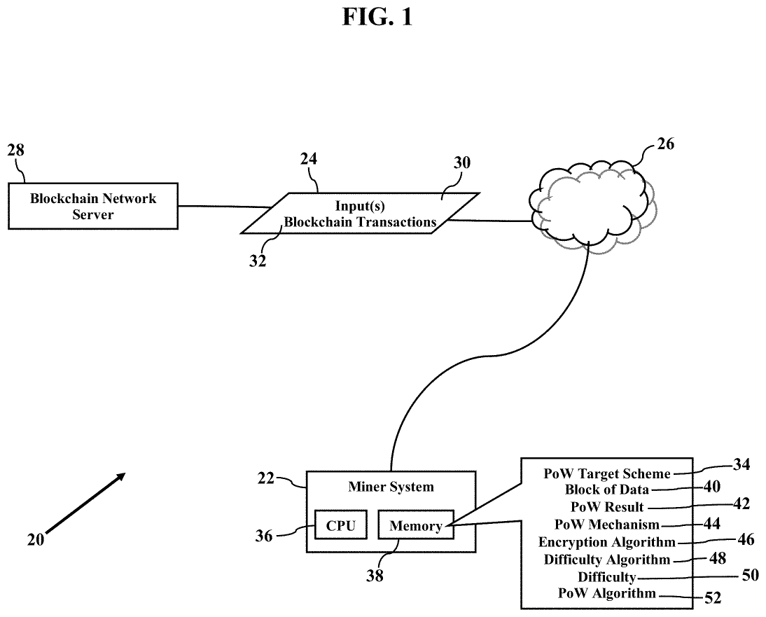

FIGS. 1-11 illustrate distributed validation in a blockchain environment 20, according to exemplary embodiments. A miner system 22 receives one or more inputs 24 via a communications network 26 from a blockchain network server 28. While the inputs 24 may be any electronic data 30, in the blockchain environment 20, the inputs 24 may be blockchain transactions 32 (such as financial transactions, inventory/shipping data, and/or healthcare medical data). The actual form or content represented by the electronic data 30 and the blockchain transactions 32 may be unimportant. The blockchain network server 28 sends, distributes, or broadcasts the inputs 24 to some or all of the authorized mining participants (such as the miner system 22). The blockchain network server 28 may also specify a proof-of-work (“PoW”) target scheme 34, which may accompany the inputs 24 or be separately sent from the inputs 24.

The miner system 22 performs mining operations. When the miner system 22 receives the inputs 24, the miner system 22 has a hardware processor (such as CPU 36) and a solid-state memory device 38 that collects the inputs 24 (such as the blockchain transactions 32) into a block 40 of data. The miner system 22 finds a difficult proof-of-work (“PoW”) result 42 based on the block 40 of data. The miner system 22 performs, executes, or calls/requests a proof-of-work (“PoW”) mechanism 44. The proof-of-work mechanism 44 is a computer program, instruction(s), or code that instructs or causes the miner system 22 to call, request, and/or execute an encryption algorithm 46. The proof-of-work mechanism 44 may instruct or cause the miner system 22 to call, request, and/or execute a difficulty algorithm 48 that generates or creates a difficulty 50. The proof-of-work mechanism 44 may also instruct or cause the miner system 22 to call, request, and/or execute a proof-of-work (“PoW”) algorithm 52. The proof-of-work mechanism 44 may thus be one or more software applications or programming schemes that separate the encryption algorithm 46 from the difficulty algorithm 48 and/or from the proof-of-work algorithm 52. Because the encryption algorithm 46 may be separately executed/called from the difficulty algorithm 48 and/or from the proof-of-work algorithm 52, encryption of the electronic data 30 (representing the inputs 24) may be separately performed from the difficulty 50 of solving the proof-of-work. In other words, any encryption algorithm 46 may be used, along with any difficulty algorithm 48, and/or along with any proof-of-work algorithm 52.

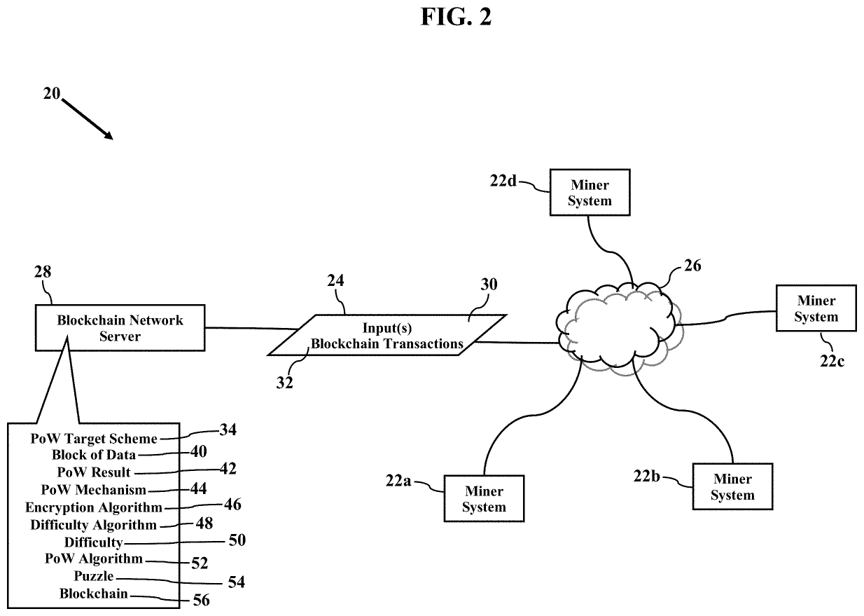

As FIG. 2 illustrates, many miners may compete to own the block 40 of data. Today's blockchain environment 20 may include many hundreds, thousands, or millions of mining machines/participants that compete to process the block 40 of data. Such a large number of miners is too difficult to illustrate. For simplicity, then, FIG. 2 only illustrates four (4) miner systems 22a-d. The blockchain network server 28 sends, distributes, or broadcasts any of the inputs 24 (via the communications network 26) to some or all of the authorized mining participants 22a-d. The miners then compete to be the first to satisfy the proof-of-work target scheme 34 (e.g., the proof-of-work result 42 satisfies a mathematical problem or puzzle 54, such as a hash match or value). Any solution to the mathematical problem or puzzle 54 is usually discovered using trial-and-error schemes, which require substantial computing (hardware processor and memory) resources and electrical power. The winning or successful miner system (say 22a) may timestamp the block 40 of data and broadcast the block 40 of data, the timestamp, the proof-of-work result 42, and/or the mathematical problem or puzzle 54 to other miners 22b-d in the blockchain environment 20. The miner system 22a, for example, may broadcast a hash value representing the block 40 of data, and the other miners begin working on a next block in the blockchain 56.

Today's difficulty is increasing. For example, on or about Jun. 16, 2020, BITCOIN's network adjusted its difficulty level (the measure of how hard it is for miners to compete for block rewards on the blockchain) to 15.78 trillion, which was nearly a 15% increase in the difficulty 50. As the difficulty 50 increases, older, less capable, and less power efficient miners are unable to compete. As a result, today's BITCOIN® miners must have the latest, fastest hardware (such as an ASIC) to profitably solve the mathematical problem or puzzle 54 according to the proof-of-work target scheme 34. Indeed, Satoshi envisioned that increasing hardware speed would allow miners to easier solve the proof-of-work. Satoshi thus explained that the difficulty 50 would be a moving target to slow down generation of the blocks 40 of data. BITCOIN's difficulty mechanism is thus a measure of how difficult it is to mine a BITCOIN® block of data. BITCOIN® miners are required to find a hash value below a given target (e.g., SHA256(nonce+input) has n leading zeros, where n determines the mining difficulty). The difficulty adjustment is directly related to the total estimated mining power (sometimes estimated in Total Hash Rate per second). BITCOIN's difficulty mechanism is adjusted to basically ensure that ten (10) minutes of computation are required before a miner may solve the mathematical problem or puzzle 54.

Conventional schemes force the use of specialized hardware. When blockchain mining first appeared, home/desktop computers and laptops (and their conventional processors or CPUs) were adequate. However, as blockchain mining became more difficult and competitive, miners gained an advantage by repurposing a dedicated graphics processing unit (or GPU) for blockchain mining. As an example, the RADEON® HD 5970 GPU has a clocked processing speed of executing about 3,200 of 32-bit instructions per clock, which is about 800 times more than the speed of a CPU that executes only four (4) 32-bit instructions per clock. This increased processor clock speed allowed GPUs to perform far more calculations and made GPUs more desirable for cryptocurrency/blockchain mining. Later, field programmable gate arrays (FPGAs) were also re-modeled for cryptocurrency/blockchain mining. FPGAs were able to compute the mathematical operations required to mine the block 40 of data twice as fast as the GPU. However, FPGA devices were more labor-intensive to build and still require customized configurations (both software programming and hardware). Today's BITCOIN® miners have pushed the hardware requirements even further by using a specialized application-specific integrated circuit (ASIC) that is exclusively designed for blockchain mining. These ASICs may be 100 billion times faster than mere CPUs. These ASICs have made BITCOIN® mining undemocratic and only possible by a relatively few, well capitalized entities running mining farms. Today's BITCOIN® miners thus consume great quantities of electrical power and pose concerns for the electrical grid.

Today's conventional mining hardware has further specialized. Some ASICs have also been further designed for particular blockchains to achieve additional optimizations. For example, a hardware implementation of the SHA-256 hash is much faster than a version coded in software. Today, nearly all BITCOIN® mining is performed using hardware ASICs. Specialized hardware has even been developed for particular hashing functions. The RAVENCOIN® scheme, as an example, uses several different hashing algorithms, and a particular hashing algorithm is picked for one block based off of a hash of a previous block (the RAVENCOIN® scheme resembles a random selection of the hashing algorithm). However, because fifteen (15) of the sixteen (16) algorithms sit on the sidelines unused at any given time, the RAVENCOIN® scheme makes it very expensive for a miner to buy sixteen (16) different hardware rigs in order to mine according to the RAVENCOIN® scheme. Even if a miner decides to only mine the blocks that match a particular hardware requirement, the hardware still sits idle 14-15 cycles on average.

Some blockchains may also alter or modify the mining scheme. For example, the MONERO® mining scheme uses a specialized hashing function that implements a random change. That is, the MONERO® mining scheme uses a hash algorithm that unpredictably rewrites itself. The MONERO® mining network introduced a RandomX mining algorithm that was designed to deter ASICs and to improve the efficiency of conventional CPUs. MONERO's RandomX mining algorithm uses random code execution and memory-intensive techniques, rendering ASICs too expensive and ineffective to develop.

The conventional mining schemes thus have many disadvantages. Conventional mining schemes have become so specialized and so expensive that only a small number of large miners have the resources to compete. Blockchain mining, in other words, has become centralized and undemocratic. Some conventional schemes try to find new hashing algorithms, new proof-of-work schemes, or modify existing schemes to de-centralize and to democratize mining participants. Some conventional mining schemes (such as ETHERTUIM®) require very large memory spaces in bytes, which disadvantages its hardware. LITECOIN® also disadvantages hardware by copying large byte amounts of data.

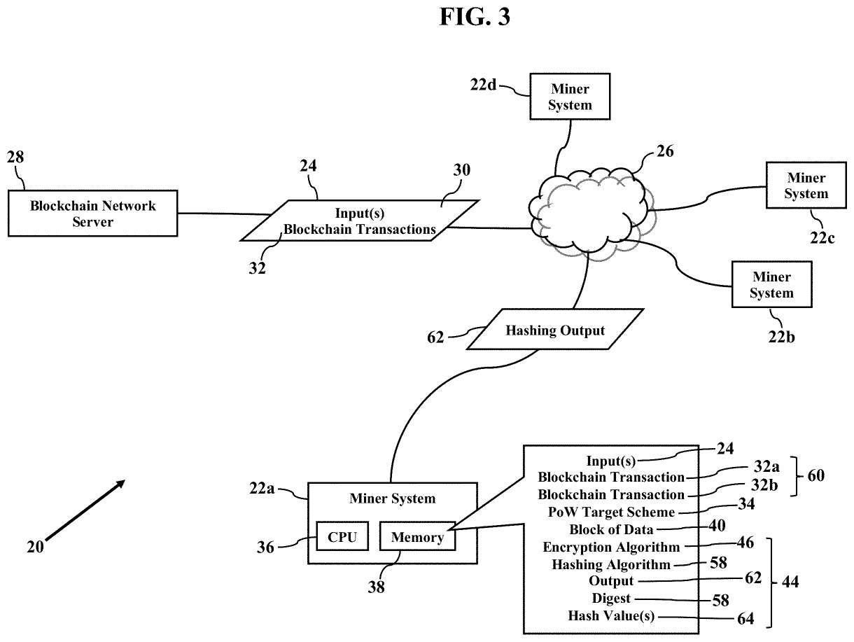

FIG. 3 illustrates distributed blockchain verification. Because encryption, difficulty, and/or proof-of-work efforts may be functionally divided/separated, computer functioning may be further improved. As FIG. 3 illustrates, for example, the cryptographical processing (such as a hashing algorithm 58) may be distributed among multiple client machines. When the blockchain network server 28 sends the inputs 24 (such as the blockchain transactions 32) into the blockchain environment 20 (via the communications network 26), the miner system 22a may be instructed to process or “mine” only a specified portion or subset 60 of the blockchain transactions 32. As a very simple example, suppose the miner system 22a is instructed to encrypt only two blockchain transactions 32a and 32b written to, recorded to, and/or associated with the block 40 of data. That is, even though there may be hundreds, thousands, millions, or more blockchain transactions recorded/written to the block 40 of data, the miner system 22 may be assigned to encrypt only the two individual blockchain transactions 32a and 32b. The miner system 22 generates a micro-hashing output 62 (e.g., a hash value(s) 64) representing the portion or subset 60 (i.e., the blockchain transactions 32a and 32b) by executing the encryption algorithm 46 using the blockchain transactions 32a and 32b as at least partial inputs. Once the miner system 22a hashes its assigned two blockchain transactions 32a and 32b, the miner system 22a may then send its partial or micro-hashing output 62 (e.g., the hash value(s) 64) to any destination. For simplicity, FIG. 3 illustrates the micro-hashing output 62 being return sent via the blockchain environment 20 and/or the communications network 26 back to the IP address associated with the blockchain network server 28. The micro-hashing output 62, however, may be addressed to any network destination or device, as later paragraphs will explain.

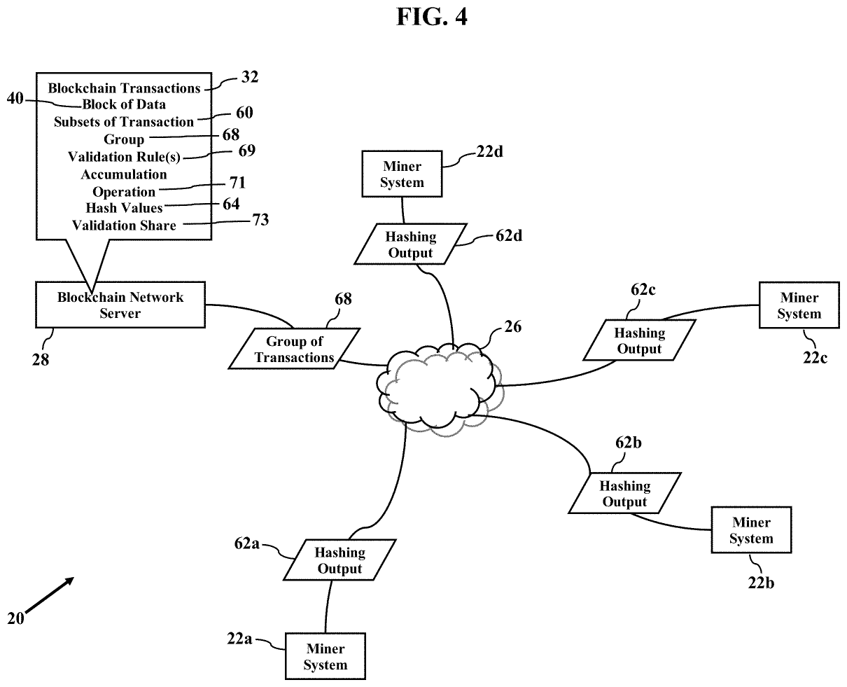

FIG. 4 illustrates an accumulation of encryption outputs. The blockchain network server 28 may receive multiple micro-hashing outputs 62 reported by any of the multiple miner systems (e.g., 22a-d) that are credentialed members of the blockchain environment 20. Recall that the block 40 of data may be associated with hundreds or more of the blockchain transactions 32 (as explained with reference to FIGS. 1-3). The blockchain network server 28 may form multiple portions or subsets 60 of the blockchain transactions 32 by segregating separate groups 68, with each individual blockchain transaction 32 assigned to or associated with a different group 68. Each group 68 may contain at least one single blockchain transaction 32, but each group may be associated with two (2) or more blockchain transactions 32. The blockchain network server 28 may then assign each group 68 of the blockchain transactions 32 to at least one of the miner systems 22 for processing/mining. The blockchain network server 28, for example, may execute one or more logical encryption validation rules 69 that define which blockchain transactions 32, and/or how many blockchain transactions 32, are assigned to each miner system 22 authorized to operate in the blockchain environment 20. Once the group 68 of the blockchain transactions 32 is assigned to a corresponding miner system 22, the blockchain network server 28 sends the group 68 of the blockchain transactions 32 via the blockchain environment 20 and/or the communications network 26 to the IP address associated with the corresponding miner system 22. The corresponding miner system 22 generates its corresponding hashing output 62 (e.g., the hash value(s) 64) generated by hashing the group 68 as inputs to the encryption algorithm 46, as explained with reference to FIGS. 1-3). The corresponding miner system 22a-d may then send its corresponding hashing output 62a-d via the blockchain environment 20 and/or the communications network 26 to the IP address associated with the blockchain network server 28. Because the blockchain network server 28 may disperse or distribute the groups 68 of the blockchain transactions 32 to multiple miner systems 22, the blockchain network server 28 may receive multiple hashing outputs 62a-d, with each mini- or micro-hashing output 62 reported by a corresponding one of the multiple miner systems 22a-d. The blockchain network server 28 may thus perform a hashing accumulation operation 71 that gathers or accumulates the componentry hash values 64 representing separate encryptions of the groups 68 of the blockchain transactions 32. Each miner system 22a-d, in other words, may contribute an encryption or validation share 73 of the total encryption/validation processing that is required to mine the blockchain transactions 32 written to, recorded to, and/or associated with the block 40 of data. The multiple miner systems 22a-d may thus pool their computing resources to verify blockchain transactions 32.

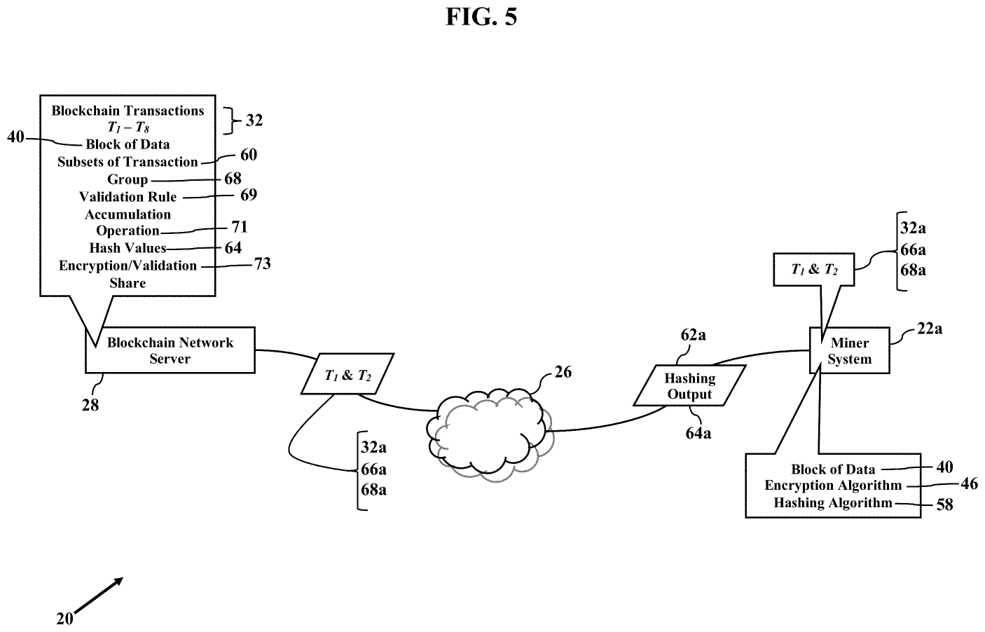

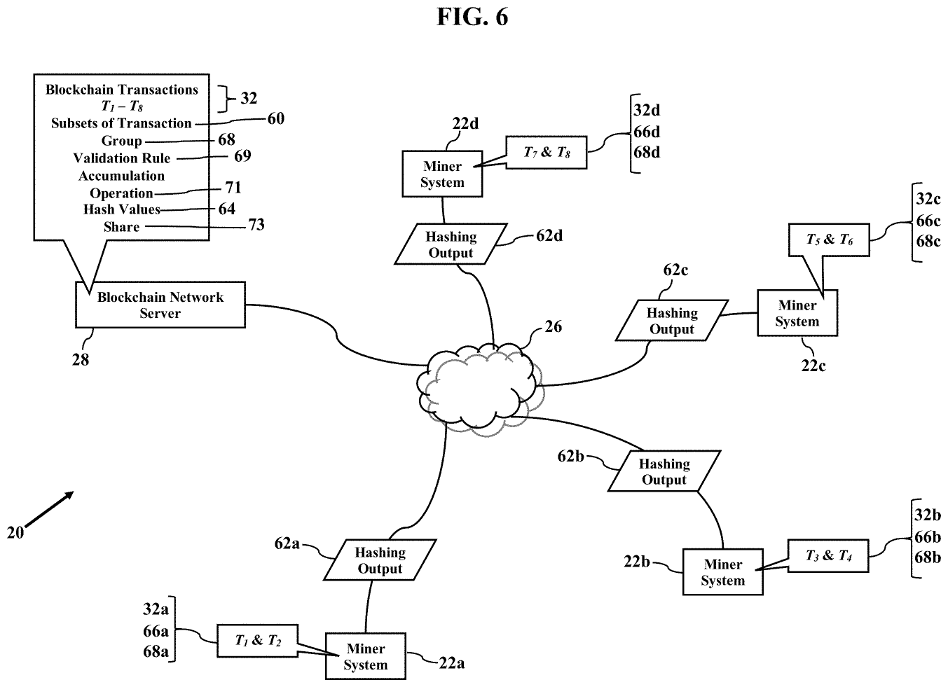

FIGS. 5-6 further illustrate shared encryption and validation. Suppose eight (8) blockchain transactions 32 are written to, recorded to, and/or associated with the block 40 of data. Again, in actual practice, the block 40 of data may be associated with hundreds or more of the blockchain transactions 32. Such a large number of the blockchain transactions 32 is too difficult to illustrate. FIG. 5, for simplicity, thus only illustrates the eight (8) blockchain transactions 32 (e.g., T₁-T₈). To reduce processor and memory workloads, suppose also that the blockchain network server 28 instructs the miner system 22a to only encrypt or hash the subset 60a, identified as T₁-T₂ of the blockchain transactions 32a. The blockchain network server 28 may send T₁ and T₂ to the miner system 22a, or the blockchain network server 28 may instruct the miner system 22a to retrieve T₁ and T₂ from any networked device, resource, or location. So, even though block 40 of data may contain the eight (8) blockchain transactions 32 (e.g., T₁-T₈), the miner system 22a need only utilize its processor and memory resources to encrypt or hash T₁ and T₂ of the blockchain transactions 32. The miner system 22a, in other words, need not be burdened with encrypting all eight (T₁-T₈) of the blockchain transactions 32.

FIG. 5 also illustrates the accumulation operation 71. The miner system 22a generates its micro-hashing output 62a by encrypting T₁ and T₂ of the blockchain transactions 32. While any encryption algorithm 46 may be used, most readers are thought familiar with the hashing algorithm 58. The miner system 22a generates its micro-hashing output 62a by concatenating/encrypting/hashing T₁ and T₂ of the blockchain transactions 32. The miner system 22a may then send the resultant hash value(s) 64a via the blockchain environment 20 and/or the communications network 26 to the IP address associated with the blockchain network server 28.

FIG. 6 further illustrates shared encryption and validation. Because the miner system 22a only encrypted/validated T₁ and T₂ of the eight (8) blockchain transactions 32, other miner systems 22 may also share the encryption/validation burden. The miner system 22b, for example, may be instructed to only encrypt the subset 60b, identified as T₃-T₄ of the blockchain transactions 32. The miner system 22b generates and sends its micro-hashing output 62b by concatenating/encrypting/hashing T₃-T₄ of the blockchain transactions 32. The miner system 22c may be instructed to report the encryption of the subset 60c, identified as T₅-T₆ of the blockchain transactions 32. The miner system 22d may be instructed to report the encryption of the subset 60d, identified as T₇-T₈ of the blockchain transactions 32. The miner systems 22a-d may thus split or carve the total encryption burden of the blockchain transactions 32, with each miner systems 22a-d performing only a portion (e.g., its assigned subset 66) of the total hardware and memory requirement. No single miner system 22, in other words, need be burdened with encrypting the entire T₁-T₈ of the blockchain transactions 32. Each miner system 22a-d thus encrypts its assigned subset 60 and/or group 68 of the blockchain transactions 32, perhaps according to its corresponding share 73, in less time and using less hardware resources. The multiple miner systems 22a-d may thus pool their computing resources to verify blockchain transactions 32.

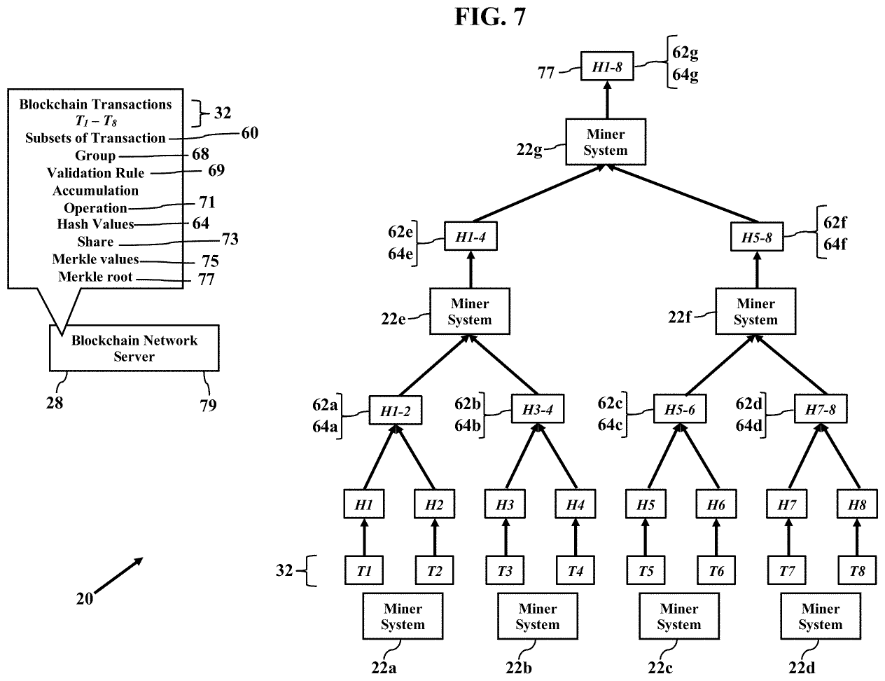

FIG. 7 further illustrates the accumulation operation 71. The blockchain network server 28 may receive the micro-hashing outputs 62a-d respectively reported by the miner systems 22a-d. If still more encryption is required, more miner systems 22 may be called for additional encryption. For example, the blockchain network server 28 may instruct the miner system 22e to further concatenate/encrypt/hash the micro-hash outputs 62a-b (e.g., the hash values 64a-b representing T₁-T₄ of the blockchain transactions 32). The blockchain network server 28 may send the hash values 64a-b to the miner system 22e, or the blockchain network server 28 may instruct the miner system 22e to retrieve the hash values 64a-b from any networked device, resource, or location. Regardless, the miner system 22e encrypts the hash values 64a-b (representing T₁-T₄ of the blockchain transactions 32). The miner system 22e may then reports its resulting micro-hash report 56e (e.g., hash value 64e), perhaps back to the blockchain network server 28. The blockchain network server 28 may also instruct the miner system 22f to further encrypt and report the micro-hash outputs 62c-d (e.g., the hash values 64c-d representing T₅-T₈ of the blockchain transactions 32). Lastly, the blockchain network server 28 may instruct the miner system 22g to further encrypt and report the micro-hash output 62g (e.g., the final hash value 64g representing the encrypted T₁-T₈ of the blockchain transactions 32). The blockchain network server 28 may thus instruct the miner systems 22a-g to generate individual, hierarchical nodal Merkle values 75, with lower tiered hash values as leaf/branch inputs and outputs in a Merkle-tree analysis. Each miner systems 22a-g may thus calculatedly contribute to the final Merkle root 77 representing the encryption of the blockchain transactions 32. The miner systems 22a-g, in other words, crowd-calculate, crowd-encrypt, or crowd-validate the Merkle values 75 and the Merkle root 77.

The Merkle tree provides a useful analogy. As FIG. 7 also illustrates, exemplary embodiments may break out the construction of Merkle trees, basically the cryptographic proofs inside of the blockchain 56, from the validation of the data that goes into it. Different miner systems 22 may be assigned to determine a corresponding cryptographic hash of any leaf or branch (using child nodes as inputs). Any miner system 22 need only be fed or given the lower-tiered, child inputs. The miner system 22 need not store and encrypt every Merkle nodal value. Exemplary embodiments may distribute the blockchain storage and may distribute the validation of processes. Exemplary embodiments thus permit unbounded numbers of the blockchain transactions 32 on the blockchain 56. Validation of the any data (such as the blockchain transactions 32) may occur locally in the blockchain 56. Once the data is validated, streams of the hash values 64 may be passed to any accumulator device 79. FIG. 7 illustrates the blockchain network server 28 functioning as the accumulator device 79, thus assigning and/or collecting the individual nodal leaf/branch inputs and outputs in the Merkle-tree analysis. The accumulator device 79, however, may be any client, server, or device having access permission to the blockchain network 20, the blockchain transactions 32, and/or the outputs 62 generated by the miner systems 20. As another example, the accumulator device 79 may be any miner system 22 that locally functions as the accumulator (such as using its processor/memory chassis, or allocating a virtual machine that shares its processor/memory chassis).

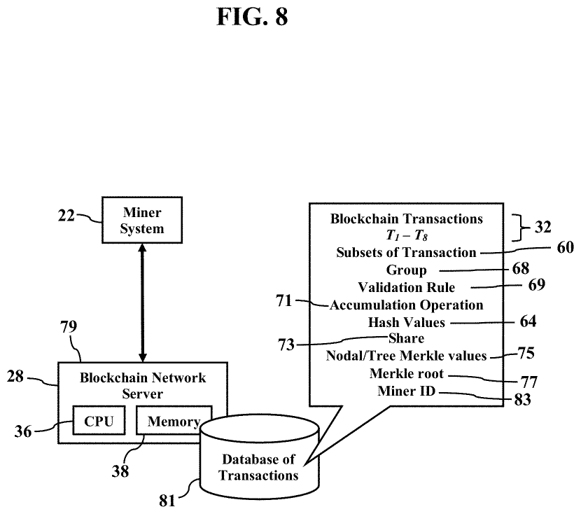

As FIG. 8 illustrates, exemplary embodiments may track encryptions of the blockchain transactions 32. Whatever the accumulator device 79 (again illustrated as the blockchain network server 28), the accumulator device 79 may collect/accumulate the Merkle values 75 and build the Merkle tree (e.g., using the hash values 64 reported by each miner system 22), perhaps according to its encryption/validation share 73 of the blockchain transactions 32. Moreover, Merkle leaf values, branch values, and/or the Merkle root 77 may be distributed to other miner systems 22 or other blockchain nodes. Exemplary embodiments may thus store, maintain, and update a database 81 of the blockchain transactions 32 with new/modified entries that log, populate, and/or share the Merkle values 75 (leaves, branches, and the Merkle root 77) representing the blockchain transactions 32 and/or the block 40 of data. The database 81 may thus have entries that relate each blockchain transaction 32 to its corresponding subset 60, group 68, validation rule 69, share 73, and the Merkle value(s) 75 calculated by the corresponding miner system 22 (such an Internet protocol address or other alphanumeric miner identifier 83) using the blockchain transaction 32. In plain words, the database 81 stores each blockchain transaction 32, its encrypting miner system 22, and its corresponding Merkle value 75. The database 81 may thus map the miner systems 22 to their corresponding nodal Merkle values 75 (and final Merkle root 77). The accumulator device 79 may thus easily perform database lookups to identify and retrieve any of the nodal Merkle values 75 associated with encrypting the blockchain transactions 32 and/or the block 40 of data.

Exemplary embodiments thus reduce network packet traffic. Because the database 81 accumulates and stores the nodal Merkle values 75 in the Merkle tree analysis, the nodal/leaf/branch/child hash values 75 need not be passed or shared around the entire communications network 36. Instead, each miner system 22 (acting as a data validator) only needs enough child data knowledge to validate its assigned data (e.g., its share 73). A particular blockchain node (such as one of the miner systems 22), in other words, may be sent a portion of data (such as child hash values) and instructed or assigned to determine the Merkle leaf/branch/node/root for just its portion of data. The Merkle tree(s) and/or any root(s) may be outsourced to different machines for small, piecewise determinations and then combined for an overall or cumulative Merkle values 75 (leaves, branches, and the Merkle root 77). Network packet traffic and congestion are reduced.

Exemplary embodiments may disperse validation operations. The blockchain network 20 may define and distribute the validation rules 69. Each miner system 22 may be assigned a share of the total validation effort (e.g., the encryption/validation share 73). The multiple miner systems 22 may thus individually validate or encrypt portions of data (such as individual, pairs, or more of the blockchain transactions 32) and provide streams of hash values to one or more accumulator devices 79 (such as the blockchain network server 28). The one or more accumulator devices 79 may build the Merkle tree for the blockchain transactions 32 and/or the block 40 of data, basically by unlimited transaction rates and higher security and faster access to the blockchain 56 using less hardware and software resources and electrical power. By localizing the validation rules and by distributing the validation, a computer's hardware processor and memory device workloads are greatly reduced, thus freeing up the computer miner's hardware processor and memory device for other computing tasks. Simply put, less computer memory bytes and processor cycles are required. Likewise, when miner clients that are called, requested, or instructed to validate particular pieces of data, miner nodes may perform those validation operations faster, as each miner may only validate a smaller subset of the data. Again, less RAM/solid-state computer memory bytes and processor cycles are required.

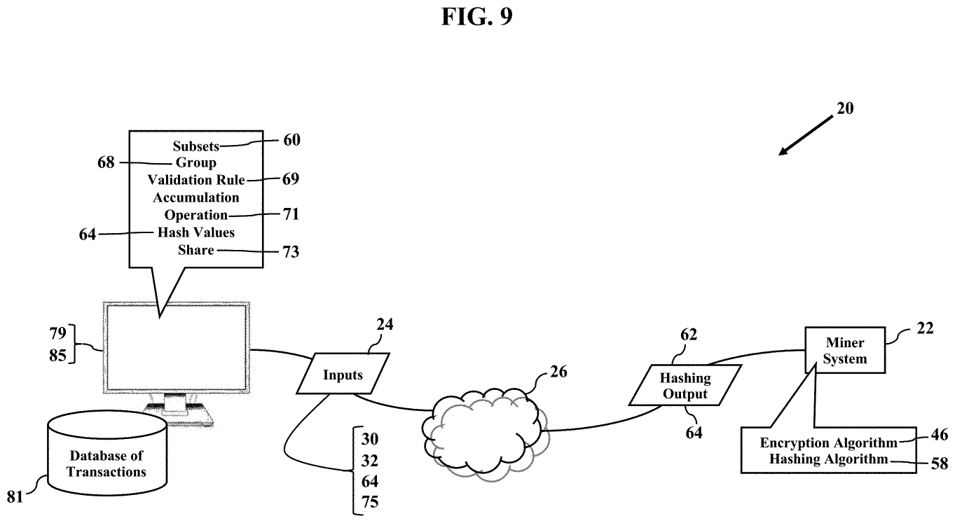

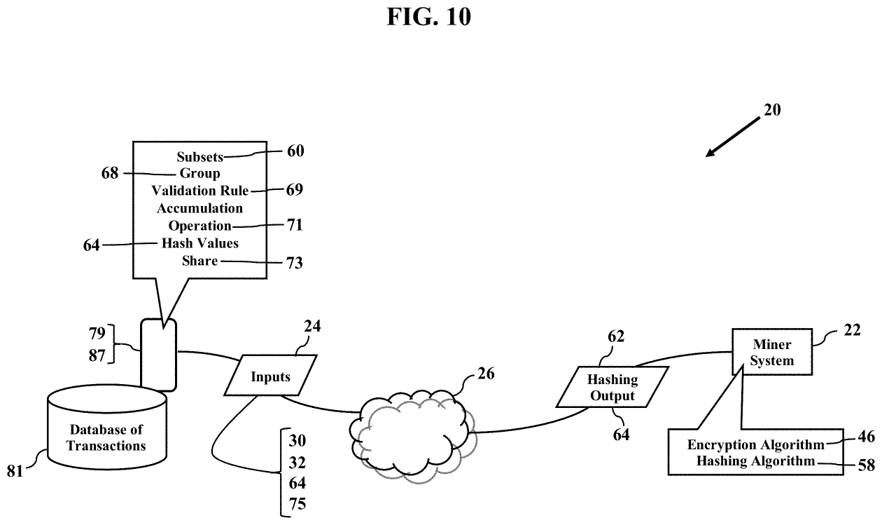

FIGS. 9-10 illustrate an accumulator-for-hire concept. The above disclosure mostly explains the blockchain network server (illustrated as reference numeral 28 in FIGS. 1-8) functioning or operating as the accumulator device 79. While the accumulator device 79 may be any server, tablet computer, desktop computer, or any processor-controlled device that accesses the communication network 26, most readers are familiar with desktop and mobile computing. FIG. 9 this illustrates the accumulator device 79 as a desktop computer 85, while FIG. 10 illustrates the accumulator device 79 as a smartphone 87. As the reader likely understands, the desktop computer 85 and the smartphone 87 each have a hardware processor, a memory device, and a network adapter (not shown for simplicity). The desktop computer 85 and the smartphone 87 each sends/receives packets of data to/from the communication network 26 via the network adapter. Because network access using the network adapter is well known, no detailed explanation is necessary. Here, though, the desktop computer 85 and/or the smartphone 87 may be hired to function as the accumulator device 79. In other words, any person's or user's desktop computer 85 and/or the smartphone 87 may be credentialed and configured to share its processor and memory capabilities for validation tasks. The desktop computer 85, in other words, may be rented/leased out by its owner/user and compensated (perhaps for a service fee, cryptocurrency, or other compensation) to act/function as the accumulator device 79. Similarly, the smartphone 87 may be rented/leased out by its owner/user and compensated (perhaps for a service fee, cryptocurrency, or other compensation) to act as the accumulator device 79. The desktop computer 85 and/or the smartphone 87 may store access credentials to the blockchain network 20 and may be approved to send the inputs 24 to any destination (such as the miner system 22). The desktop computer 85 and/or the smartphone 87 may also be approved to receive and store the outputs 62 (e.g., the hash values 64 representing Merkle values 75 and/or the Merkle root 77) reported by any miner system 22. Any miner system 22 may be configured to report its streams of hash values to the network address (IP address) registered/assigned to the desktop computer 85 and/or the smartphone 87. Any person's or user's desktop computer 85 and/or the smartphone 87 may thus earn revenue by crowdsharing its processor and memory capabilities for validation tasks. The desktop computer 85 and/or the smartphone 87 may also have access privileges to the electronic database 81, thus storing/updating logged validation records in near real time.

Compensation mat take any form. The accumulator device 79 may be compensated for using its processor and memory capabilities for validation tasks. While there are many compensation schemes (e.g., US Dollar, Euro, etc.), crypto-compensation is possible. That is, as the accumulator device 79 processes or validates the outputs 62, conventional and/or cryptographic currencies may be exchanged, traded, or transferred. The accumulator device 79 may thus be paid or rewarded for its validation services.

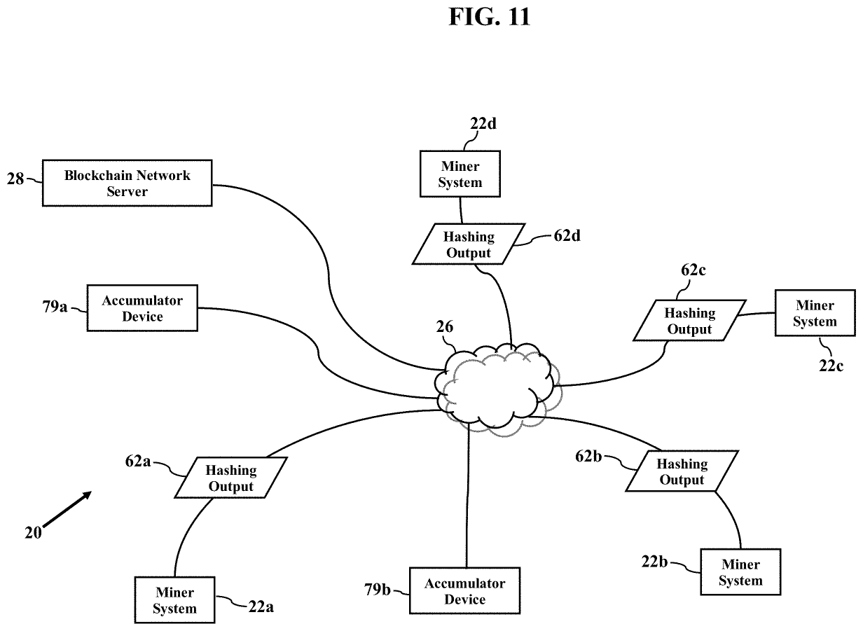

FIG. 11 illustrates scalability using multiple accumulator devices 79. Whatever the accumulator device 79 (e.g., the miner system 22, the blockchain network server 28, the desktop computer 85, and/or the smartphone 87), the accumulator device(s) 79 may collect hundreds of thousands of blockchain/processor transactions per second. In actual practice, the blockchain network 20 may have many different accumulator devices 79 providing far faster, and much greater, transaction processing. A network of ten (10) accumulator devices 79, for example, may receive and process a million transactions per second. A larger network (such as several hundred accumulator devices 79a-n) would have ample capacity to securely validate the entire electric grid of the United States, with far greater transaction rates still available. The accumulator concept is thus an extremely powerful mechanism for validating millions and billions of blockchain transactions per second.

This accumulator capability further improves computer networking. This network architecture of accumulator devices 79 greatly improves the processing power of the blockchain environment 20 and the computer network 26. The accumulator concept distributes the blockchain, thus reducing the storage bytes consumed by cache and main memory. When any computer (such as the miner system 22, the blockchain network server 28, and/or the accumulator device 79) syncs up to a blockchain, the computer need not download the whole or entire blockchain. The miner system 22, instead, need only download the piece, segment, or portion of interest. Each miner system 22 and/or accumulator device 79 thus only needs to download a much smaller block/byte portion, which consumes far less memory byte space and requires far less processor time/tasks/cycles/operations. Moreover, because each computer only needs to download a small block/byte portion of the blockchain, the number of IP packets in the communications network 26 is reduced, so traffic is reduced.

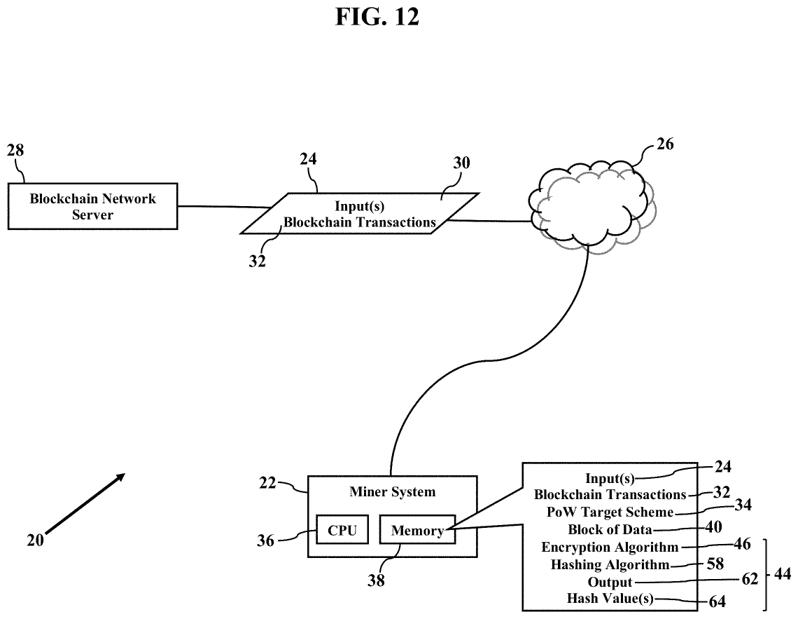

FIGS. 12-20 illustrate additional distributed processing, according to exemplary embodiments. FIG. 12, for example, further illustrates the proof-of-work mechanism 44. While the encryption algorithm 46 may utilize any encryption scheme, process, and/or function, many readers may be familiar with a cryptographic hashing algorithm 58 (such as the SHA-256). The cryptographic hashing algorithm 58 may thus generate the output 62 (sometimes called a digest) by implementing or executing the cryptographic hashing algorithm 58 using the inputs 24 (such as the blockchain transactions 32). So, whatever the arbitrary bit values of the inputs 24, and whatever the arbitrary bit length of the inputs 24, the cryptographic hashing algorithm 58 may generate the output 62 as the one or more hash values 64, perhaps having a fixed length (or n-bit). The miner system 22 may thus receive the inputs 24 from the blockchain network server 28, call and/or execute the encryption algorithm 46 (such as the cryptographic hashing algorithm 58), and generate the hash value(s) 64.

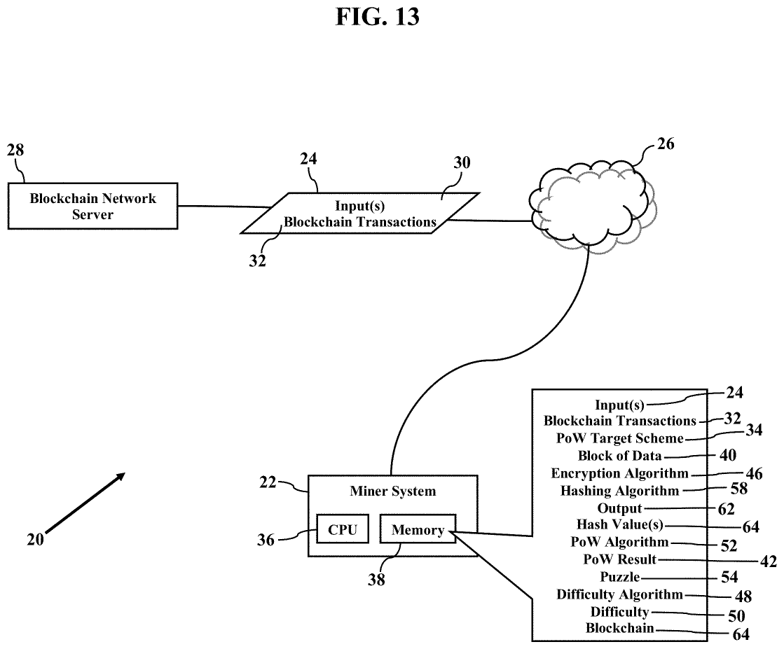

As FIG. 13 illustrates, the miner system 22 may separately perform or call the proof-of-work algorithm 52. After the encryption algorithm 46 creates the output(s) 62, the miner system 22 may read/retrieve the output(s) 62 and send the output(s) 62 to the proof-of-work algorithm 52. The miner system 22 may thus generate the proof-of-work result 42 by calling and/or by executing the proof-of-work algorithm 52 using the output(s) 62. The miner system 22, for example, may send the hash value(s) 64 (generated by the cryptographic hashing algorithm 58) to the proof-of-work algorithm 52, and the proof-of-work algorithm 52 generates the proof-of-work result 42 using the hash value(s) 64. The proof-of-work algorithm 52 may also compare the proof-of-work result 42 to the proof-of-work (“PoW”) target scheme 34. The proof-of-work algorithm 52 may, in general, have to satisfy or solve the complicated mathematical question, target, problem, or puzzle 54, perhaps defined or specified by the proof-of-work target scheme 34. The proof-of-work target scheme 34 may also specify, or relate to, the difficulty 50 of solving the mathematical puzzle 54. That is, the more stringent or precise the proof-of-work target scheme 34 (e.g., a minimum/maximum value of the hash value 64), the more difficult the mathematical problem or puzzle 54 is to solve. In other words, the difficulty 50 is a measure of how difficult it is to mine the block 40 of data, given the solution requirements of the proof-of-work target scheme 34.

Conventional mining schemes are integrated. When a conventional blockchain miner attempts to solve the mathematical problem or puzzle 54, the conventional blockchain miner executes a conventional scheme that integrates hashing, difficulty, and proof-of-work. That is, conventional proof-of-work schemes require the miners to execute a combined software offering or pre-set combination of encryption and proof. These conventional proof-of-work scheme, in other words, integrate a predetermined encryption/hashing algorithm into or with a predetermined difficulty and a predetermined proof-of-work algorithm. These conventional proof-of-work schemes thus force the miners to execute a predetermined or predefined scheme that functionally marries or bundles encryption, difficulty, and proof-of-work.

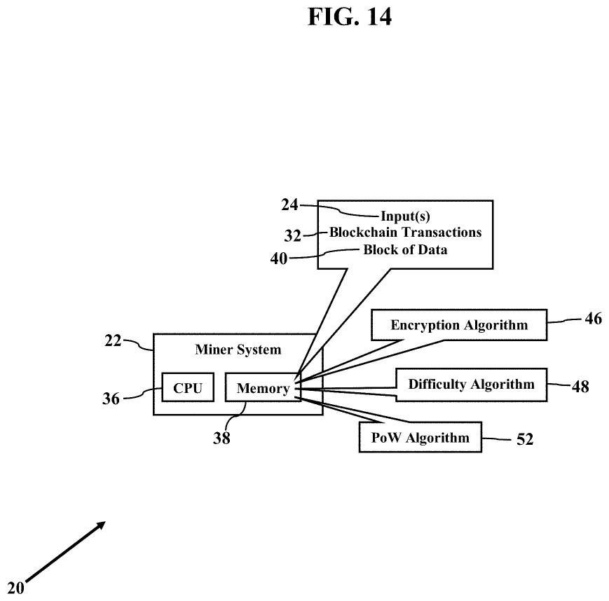

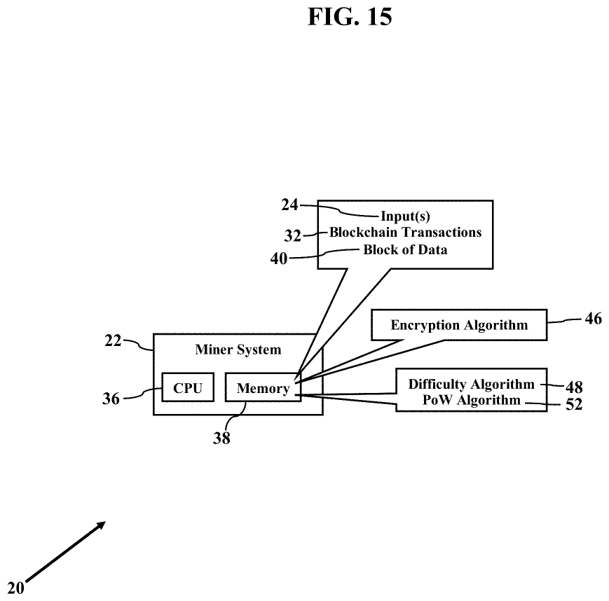

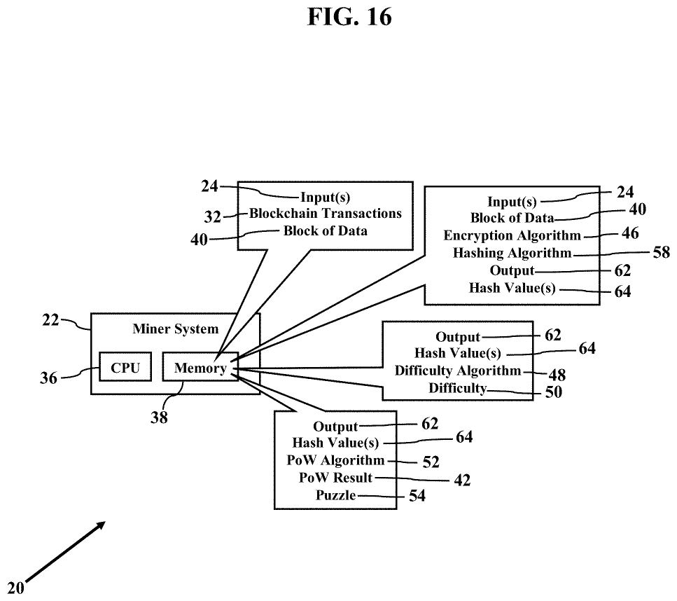

As FIGS. 14-16 illustrate, though, exemplary embodiments may mix-and-match the encryption algorithm 46, the difficulty algorithm 48, and the proof-of-work algorithm 52. The inventor has observed that there is no mining law or scheme that requires a preset or predefined difficulty scheme (such as BITCOIN'S counting zeroes on the hash to decide its difficulty). Instead, exemplary embodiments may use any encryption algorithm 46 that a cryptographic coin, network, or scheme desires or specifies. Exemplary embodiments may use any difficulty algorithm 48 that the cryptographic coin, network, or scheme desires or specifies. Exemplary embodiments may use any proof-of-work algorithm 52 that the cryptographic coin, network, or scheme desires or specifies. FIG. 14 illustrates the encryption algorithm 46, the difficulty algorithm 48, and proof-of-work algorithm 52 as separate software mechanisms. FIG. 15 illustrates an alternative software mechanism where the difficulty algorithm 48 and proof-of-work algorithm 52 may be functionally intertwined, but the encryption algorithm 46 is a separate, stand-alone program, file, or service. FIG. 16 illustrates the inputs and outputs for the encryption algorithm 46, the difficulty algorithm 48, and proof-of-work algorithm 52.

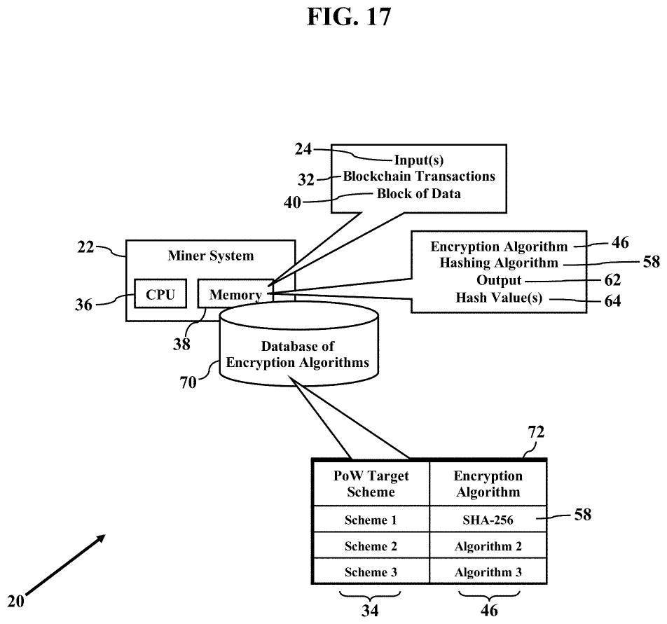

FIG. 17 illustrates agnostic hashing. Exemplary embodiments may use any encryption algorithm 46 that a cryptographic coin, blockchain network, or scheme desires or specifies. Because most blockchain mining schemes use hashing, FIG. 17 illustrates the cryptographic hashing algorithm 58. The proof-of-work (“PoW”) target scheme 34 may thus use any cryptographic hashing algorithm 58, as exemplary embodiments are agnostic to hashing/encryption. The encryption algorithm 46 may be any cryptographic hashing algorithm 58 (e.g., the SHA-2 family (SHA-256 and SHA-512) and/or the SHA-3 family). The miner system 22 need only request, call, and/or execute the particular cryptographic hashing algorithm 58 specified by the proof-of-work target scheme 34. FIG. 17 thus illustrates an electronic database 70 of encryption algorithms accessible to the miner system 22. While the database 70 of encryption algorithms is illustrated as being locally stored in the memory device 38 of the miner system 22, the database 70 of encryption algorithms may be remotely stored and accessed/queried at any networked location. Even though the database 70 of encryption algorithms may have any logical structure, a relational database is perhaps easiest to understand. FIG. 17 thus illustrates the database 70 of encryption algorithms as an electronic table 72 that maps, converts, or translates different proof-of-work target schemes 34 to their corresponding or associated encryption algorithm 46 (such as the particular cryptographic hashing algorithm 58). The miner system 22 may thus identify the encryption algorithm 46 by querying the electronic database 70 of encryption algorithms for the proof-of-work target scheme 34 specified for use by the blockchain environment 20. So, once the particular cryptographic hashing algorithm 58 is identified, the miner system 22 may acquire or retrieve any inputs 24 (such as the blockchain transactions 32) and execute the cryptographic hashing algorithm 58 specified by the proof-of-work target scheme 34. The miner system 22 may optionally send the inputs 24 via the Internet or other network (e.g., the communications network 26) to a remote destination for service execution (as later paragraphs will explain). The encryption algorithm 46 (e.g., the cryptographic hashing algorithm 58 specified by the proof-of-work target scheme 34) may thus generate the output 62 represented as the hash value(s) 64.

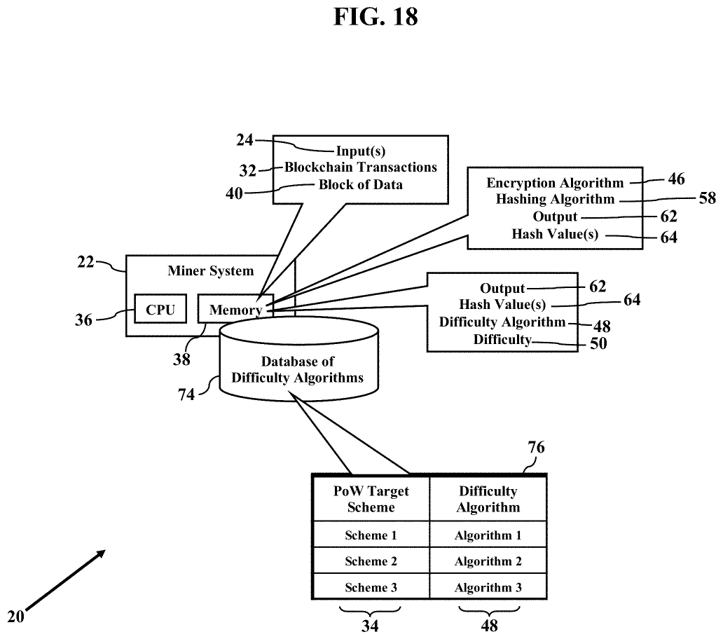

FIG. 18 illustrates agnostic difficulty. Exemplary embodiments may use any difficulty algorithm 48 that a cryptographic coin, blockchain network, or scheme desires or specifies. For example, when or even after the encryption algorithm 46 (e.g., the cryptographic hashing algorithm 58) generates the output 62 (such as the hash value(s) 64), the miner system 22 may request, call, and/or execute the particular difficulty algorithm 48 selected by, or specified by, the proof-of-work target scheme 34 and/or the blockchain environment 20. The proof-of-work target scheme 34 may thus use any difficulty algorithm 48, as the miner system 22 is agnostic to difficulty. FIG. 18, for example, illustrates an electronic database 74 of difficulty algorithms that is accessible to the miner system 22. While the database 74 of difficulty algorithms is illustrated as being locally stored in the memory device 38 of the miner system 22, the database 74 of difficulty algorithms may be remotely stored and accessed/queried at any networked location. Even though the database 74 of difficulty algorithms may have any logical structure, a relational database is again perhaps easiest to understand. FIG. 18 thus illustrates the database 74 of difficulty algorithms as an electronic table 76 that maps, converts, or translates different proof-of-work target schemes 34 to their corresponding or associated difficulty algorithm 48 (such as the particular cryptographic hashing algorithm 58). The miner system 22 may thus identify the difficulty algorithm 48 by querying the electronic database 74 of difficulty algorithms. So, once the particular difficulty algorithm 48 is identified, the miner system 22 may acquire or retrieve any inputs that are required by the difficulty algorithm 48 (such as the output hash value(s) 64 generated by the cryptographic hashing algorithm 58). The miner system 22 may execute the difficulty algorithm 48 specified by the proof-of-work target scheme 34. The miner system 22 may optionally send the hash value(s) 64 via the Internet or other network (e.g., the communications network 26) to a remote destination for service execution. The difficulty algorithm 48 creates or generates the difficulty 50 based on the hash value(s) 64.

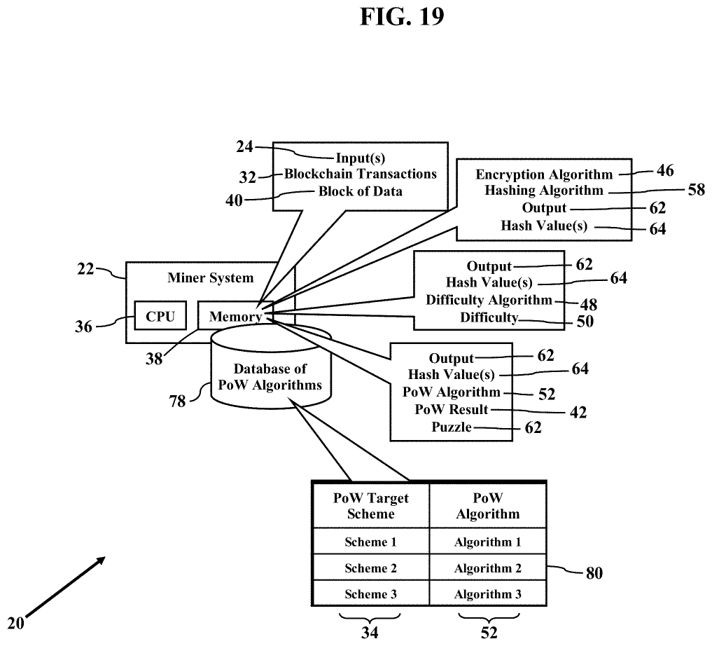

FIG. 19 illustrates agnostic proof-of-work. Exemplary embodiments may use any proof-of-work algorithm 52 that a cryptographic coin, blockchain network, or scheme desires or specifies. The proof-of-work target scheme 34 may thus use any proof-of-work algorithm 52, as the miner system 22 is agnostic to encryption, difficulty, and/or proof-of-work. FIG. 19, for example, illustrates an electronic database 78 of proof-of-work algorithms that is accessible to the miner system 22. While the database 78 of proof-of-work algorithms is illustrated as being locally stored in the memory device 38 of the miner system 22, the database 78 of proof-of-work algorithms may be remotely stored and accessed/queried at any networked location. Even though the database 78 of proof-of-work algorithms may have any logical structure, a relational database is again perhaps easiest to understand. FIG. 19 thus illustrates the database 78 of proof-of-work algorithms as an electronic table 80 that maps, converts, or translates different proof-of-work target schemes 34 to their corresponding proof-of-work algorithm 52. The miner system 22 may thus identify the proof-of-work algorithm 52 by querying the electronic database 78 of proof-of-work algorithms. After the hash value(s) 64 are generated, and perhaps after the difficulty 50 is generated, the miner system 22 may execute the proof-of-work algorithm 52 (specified by the proof-of-work target scheme 34) using the hash value(s) 64 and/or the difficulty 50 as inputs. The miner system 22 may optionally send the hash value(s) 64 and/or the difficulty 50 via the Internet or other network to a remote destination for service execution. The proof-of-work algorithm 52 generates the proof-of-work result 42 using the hash value(s) 64 and/or the difficulty 50. The proof-of-work algorithm 52 may also compare the proof-of-work result 42 to the proof-of-work (“PoW”) target scheme 34 to ensure or to prove a solution to the mathematical problem or puzzle 54.

Exemplary embodiments may thus use any encryption algorithm 46, any difficulty algorithm 48, and/or any proof-of-work algorithm 52. Exemplary embodiments may implement any cryptographic security. Instead of merely counting zeroes (as specified by BITCOIN®), exemplary embodiments may run the resulting hash value 64 through the difficulty algorithm 48 to calculate the difficulty 50 in order to determine whether it's more or less difficult than other hashes.

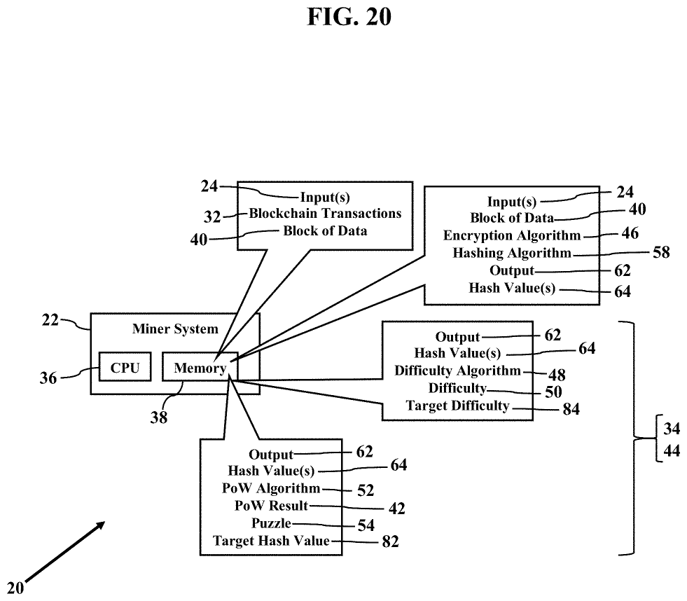

As FIG. 20 illustrates, exemplary embodiments may use any PoW target scheme 34. There are many different target schemes, some of which use or specify random number/nonce values, addresses, starting points, and other security schemes. The proof-of-work algorithm 52, for example, may have to compare the hash value(s) 64 to a target hash value 82. The target hash value 82 may be any minimum or maximum hash value that must be satisfied. If the hash value 64 is less than or perhaps equal to the target hash value 82, then the proof-of-work algorithm 52 has perhaps solved the mathematical problem or puzzle 54. However, if the hash value 64 is greater than the target hash value 82, then perhaps the proof-of-work algorithm 52 has failed to solve the mathematical problem or puzzle 54. Likewise, the hash value 64 may need to be equal to or greater than the target hash value 82 to be satisfactory. Regardless, should the hash value 64 fail to satisfy the target hash value 82, exemplary embodiments may modify any data or input (e.g., the electronic data 30, a random number/nonce value, address, starting points, etc.) according to the proof-of-work target scheme 34, again call or request the cryptographic hashing algorithm 58 to generate the corresponding hash value(s) 64, and compare the hash value(s) 64 to the target hash value 82. Exemplary embodiments may repeatedly modify the electronic data 30 and/or any other parameters until the corresponding hash value(s) 64 satisfy the target hash value 82.

Exemplary embodiments may also use any difficulty scheme. The inventor envisions that there will be many different difficulty schemes. The difficulty algorithm 48, for example, may have to compare the difficulty 50 to a target difficulty 84. The target difficulty 84 has a bit or numeric value that represents a satisfactory difficulty of the corresponding cryptographic hashing algorithm 58 and/or the hash value 64. For example, suppose the target difficulty 84 is a minimum value that represents a minimum permissible difficulty associated with the corresponding cryptographic hashing algorithm 58. If the difficulty 50 is less than or perhaps equal to the target difficulty 84, then perhaps the corresponding cryptographic hashing algorithm 58 and/or the hash value 64 is adequately difficult. However, if the difficulty 50 is greater than the target difficulty 84, then perhaps the corresponding cryptographic hashing algorithm 58 and/or the hash value 64 is too difficult. Likewise, the difficulty 50 may need to be equal to or greater than the target difficulty 84 to be adequately difficult. Regardless, should the difficulty 50 fail to satisfy the target difficulty 84, exemplary embodiments may modify any data or input (e.g., the electronic data 30, a random number/nonce value, address, starting points, etc.) and recompute the corresponding hash value(s) 64. Moreover, exemplary embodiments may additionally or alternatively change the cryptographic hashing algorithm 58 and/or the difficulty algorithm 48 and recompute.

Exemplary embodiments may thus functionally separate hashing/validation, difficulty, and proof-of-work. The conventional proof-of-work target scheme 34 functionally combines or performs both hashing and difficulty. The conventional proof-of-work target scheme 34 integrates or combines the difficulty in the hash. The conventional proof-of-work target scheme 34 integrates or combines the difficulty in the hash, thus greatly complicating the hash determination. Exemplary embodiments, instead, may separate the hashing algorithm 58 from the difficulty algorithm 48. Exemplary embodiments put the difficulty 50 in the measurement of the difficulty 50. Exemplary embodiments remove the difficulty 50 from the hashing algorithm 58. The hashing algorithm 58 is not complicated by also having to integrate/calculate the difficulty algorithm 48. The difficulty algorithm 48 may thus be a separate, stand-alone function or service that determines or calculates which hash is more difficult. The hashing algorithm 58 is much simpler to code and much faster to execute, as the hashing algorithm 58 requires less programming code and less storage space/usage in bytes. The hashing algorithm 58 need not be complicated to deter ASIC mining. Exemplary embodiments need not rely on the hashing algorithm 58 to also determine the difficulty 50 and/or the proof-of-work. The difficulty algorithm 48 is, instead, a separate functional mechanism, perhaps performed or executed by a service provider. Exemplary embodiments thus need not use an electrical power-hungry mechanism that is inherent in the conventional proof-of-work scheme.

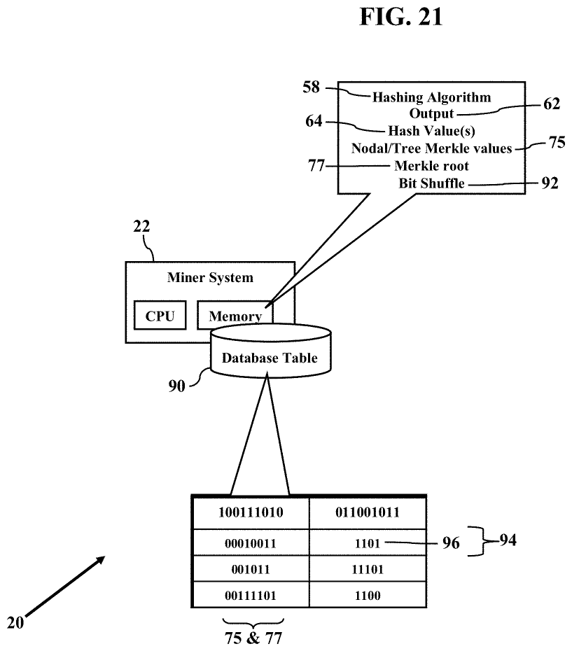

FIGS. 21-24 illustrate randomization, according to exemplary embodiments. The blockchain network 20 (such the miner system 22 and/or the accumulator device 79) may use or consult a database table 90 when conducting any encryption/validation operation. For example, the miner system 22 may implement a further randomization of the Merkle values 75 and/or the Merkle root 77. Exemplary embodiments may implement a bit shuffle operation 92 on the Merkle values 75 and/or the Merkle root 77. Exemplary embodiments may use entries in the database table 90 to perform the bit shuffle operation 92. Each entry 94 in the database table 90 may contain a random selection of bits/bytes 96. The encryption algorithm 46 may thus query the database table 90 and randomly select any entry. The encryption algorithm 46 may additionally or alternatively query the database table 90 for any Merkle value 75 and/or the Merkle root 77. If a matching bit value is found, the encryption algorithm 46 may identify and retrieve a corresponding entry having a randomized bit values. The encryption algorithm 46 may thus swap any bits or portion of the Merkle value 75 and/or the Merkle root 77 with any one or more entries 94 specified by the database table 90. The encryption algorithm 46 may read or select a bit portion of the bit values and exchange or replace the bit portion with an entry 94 contained in, or referenced by, the database table 90. Each entry 94 in the database table 90 represents or is associated with random bits or bytes. Exemplary embodiments may thus randomly shuffle any hash value(s) 64 generated by the cryptographic hashing algorithm 58. Exemplary embodiments randomize byte or memory block access. The randomized entries in the database table 90 may thus reduce hacking and increase security, further improving computer functioning.

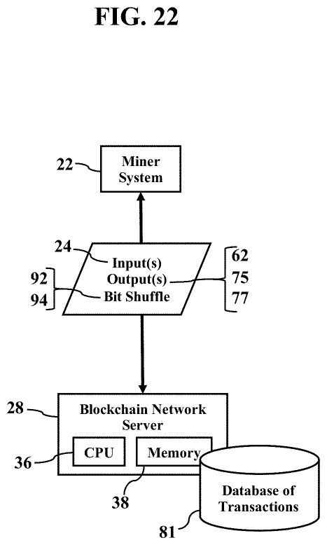

As FIG. 22 illustrates, exemplary embodiments may also track the bit shuffles. When the miner system 22 reports its hashing/validation inputs 24 and/or outputs 62, the miner system 22 may also report the corresponding bit shuffle 92. For example, the miner system 22 may send the Merkle value 75 and/or the Merkle root 77 along with any entry 94 read and swapped from the database table 90 (illustrated in FIG. 21). The blockchain network 20 (such the server 28) may execute a reporting software application (read/write operation) that logs/records/writes the randomized Merkle values (e.g., the Merkle value 75 and/or the Merkle root 77, the bit shuffle 92, and or the entry 94) in the database 81, thus perhaps generating a central repository of the blockchain transactions 32 and their validation operations. Moreover, the randomized Merkle values (generated as a result of the bit shuffle 92) may be distributed to other miner systems 22 or other blockchain nodes. Exemplary embodiments may thus store, maintain, and update the database 81 of the blockchain transactions 32 with new/modified entries that log, populate, and/or share the randomized Merkle values.

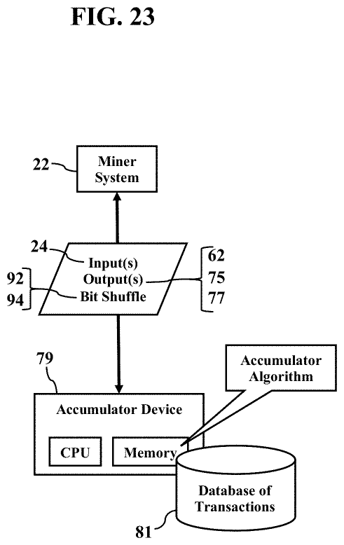

FIG. 23 illustrates accumulator updates. The miner system 22 may additionally or alternatively report its hashing/validation input 24, output 62, and/or bit shuffle 92 to the accumulator device 79. Whatever the accumulator device 79, the accumulator device 79 has a hardware processor that executes an accumulator software application or algorithm stored in a solid-state memory device. The accumulator software application causes or instructs the accumulator device 79 to receive and to store the Merkle values 75 reported by the blockchain environment 20 (such as the miner systems 22, as above explained). The accumulator software application causes or instructs the accumulator device 79 to populate the database 81 using a read/write operation, thus perhaps generating a central repository of the blockchain transactions 32 and their validation operations. The accumulator device 79 may then log the randomized Merkle values (e.g., the Merkle value 75 and/or the Merkle root 77, the bit shuffle 92, and or the entry 94) in the database 81. Moreover, miner system 22 and/or the accumulator device 79 may share or report the randomized Merkle values to other miner systems 22 or other blockchain nodes. The accumulator device 79 may thus store, maintain, access, and/or update the database 81 of the blockchain transactions 32 with new/modified entries that log, populate, and/or share the randomized Merkle values.

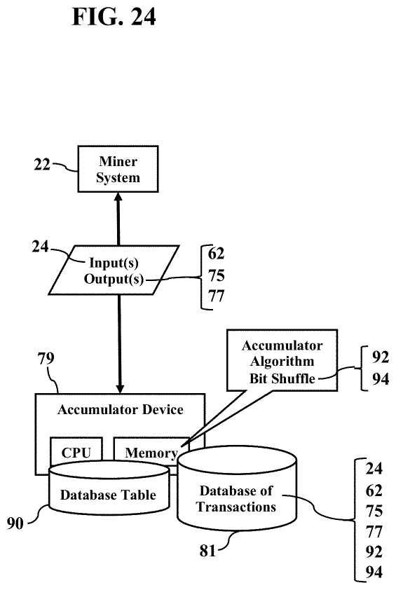

As FIG. 24, the accumulator device 79 may randomize the outputs 62. The miner system 22 may report its hashing/validation inputs 24 and/or outputs 62 to the accumulator device 79. After the accumulator device 79 receives the inputs 24 and/or outputs 62, the accumulator device 79 may implement randomization. The accumulator algorithm may cause or instruct the accumulator device 79 to perform or execute the bit shuffle 94 using the entries stored by the database table 90. The accumulator device 79 may thus swap or exchange portions of the Merkle value 75 and/or the Merkle root 77 with a database entry specifying or containing randomized bit values. The accumulator algorithm may also cause or instruct the accumulator device 79 to document the randomization by populating the database 81 (using a read/write operation) with an entry logging the bit shuffle 94. The randomized Merkle values (e.g., the Merkle value 75 and/or the Merkle root 77, the bit shuffle 92, and or the entry 94) may be shared or reported to other miner systems 22 or to other blockchain nodes. The accumulator device 79 may thus store, maintain, access, and/or update the database 81 of the blockchain transactions 32 with new/modified entries that log, populate, and/or share the randomized Merkle values. The randomized Merkle values reduce hacking and increase security, further improving computer functioning.

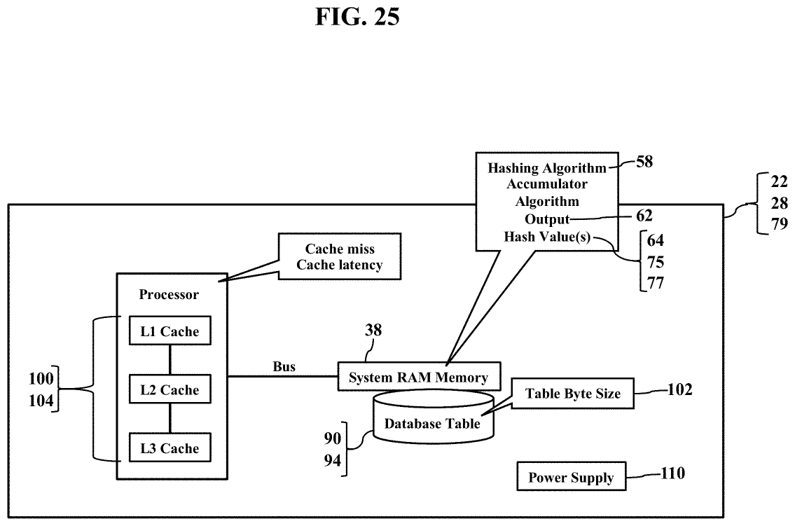

FIG. 25 illustrates RAM binding, according to exemplary embodiments. Exemplary embodiments may further discourage or deter the use of specialized hardware (such as GPUs and ASICs) in blockchain mining. The hashing algorithm 58, for example, may take advantage of, or target, memory size restrictions and cache latency of any on-board processor cache memory 100. The accumulator algorithm may also take advantage of, or target, memory size restrictions and cache latency of any on-board processor cache memory 100. As the reader may understand, any hardware processing element (whether a GPU, an ASIC, or the CPU 36) may have integrated/embedded L1, L2, and L3 SRAM/DRAM cache memory. The processor cache memory 100 is generally much smaller than a system/main memory (such as the memory device 38), so the hardware processing element may store frequently-needed data and instructions. Because the processor cache memory 100 is physically much closer to the processing core, any hardware processing element is able to quickly fetch or hit needed information. If the processor cache memory 100 does not store the needed information, then a cache miss has occurred and the hardware processing element must request and write blocks of data via a much-slower bus from the system/main memory 38. A cache miss implies a cache latency in time and/or cycles to fetch the needed information from the system/main memory 38. Any hardware processing element (again, whether a GPU, an ASIC, or the CPU 36) may sit idle, or stall, while awaiting fetches from the system/main memory 38.

Exemplary embodiments may thus force latency, cache misses, and stalls. Exemplary embodiments may target cache latency and processor stalls by generating, storing, and/or using the database table 90 when determining the hash value(s) 64 (as later paragraphs will explain). The database table 90, however, may be sized to overload the processor cache memory 100. The database table 90, in other words, may have a table byte size 102 (in bits/bytes) that exceeds a storage capacity or cache byte size 104 of the processor cache memory 100. The database table 90, for example, may exceed one gigabyte (1 GB). Today's L1, L2, and L3 processor cache memory is typically hundreds of megabits in size. Because the database table 90 may exceed one gigabyte (1 GB), any caching operation will miss or invalidate. That is, the L1, L2, and L3 processor cache memory 100 lacks the storage capacity or byte size 104 to store the entire database table 90. Perhaps only a portion (or perhaps none) of the database table 90 may be stored in the processor cache memory 100. Indeed, exemplary embodiments thus force some, most, or even all of the database table 90 to be written or stored to the main/host memory device 38 (or accessed/retrieved from a remote source, as later paragraphs will explain). Because any hardware processing element (again, whether a GPU, an ASIC, or the CPU 36) is unable to cache the entire database table 90, exemplary embodiments force a cache miss and further force the hardware processing element to repeatedly use the processor cache memory 100 to fetch and load a portion of the database table 90. The main/system memory 38 thus provides perhaps a particular portion of the database table 90 via the bus to the processor cache memory 100, and the processor cache memory 100 then provides that particular portion of the database table 90 to the hardware processing element. The hardware processing element may then purge or delete that particular portion of the database table 90 from the processor cache memory 100 and request/fetch/load another portion of the database table 90. Because exemplary embodiments may force repeated cache misses, the hardware processing element may continuously repeat this cycle for loading/retrieving most or all portions of the database table 90. The hardware processing element, in other words, repeatedly queries the processor cache memory 100 and/or the main/host memory device 38 and awaits data retrieval. The hardware processing element must therefore sit, perhaps mostly idle, while the processor cache memory 100 and/or the main/host memory device 38 processes, retrieves, and sends different entries/segments/portions/blocks of the database table 90. The processor cache memory 100 and/or the main/host memory device 38 have the cache latency (perhaps measured in clock cycles, data transfer rate, or time) that limits blockchain computations. A faster processor/GPU/ASIC, in other words, will not improve memory access times/speeds, so any computational speed/performance is limited by the latency of repeatedly accessing the processor cache memory 100 and/or the main/host memory device 38. The database table 90 thus deters GPU/ASIC usage when validating the blockchain transactions 32 and/or when randomizing the Merkle value 75 and/or the Merkle root 77. The database table 90 may thus be purposefully designed to be non-cacheable by intensively using the processor cache memory 100 and/or the main/host memory device 38 as an ASIC-deterrence mechanism.

Byte or memory block access may be randomized. Whatever the hashing algorithm 58, exemplary embodiments may implement the bit shuffle operation 92 on the hash value(s) 64. Exemplary embodiments may use the entries 94 in the database table 90 to perform the bit shuffle operation 92 (as later paragraphs will further explain). The hashing algorithm 58 and/or the accumulator algorithm may use bit values representing the Merkle value 75 and/or the Merkle root 77, but the hashing algorithm 58 and/or the accumulator algorithm may swap any one or more of the bit values with any one or more entries 94 specified by the database table 90. Each entry 94 in the database table 90 may contain a random selection of bits/bytes. The hashing algorithm 58 and/or the accumulator algorithm may read or select a bit portion of the bit values representing the hash value(s) 64 and exchange or replace the bit portion with an entry 94 contained in, or referenced by, the database table 90. Each entry 94 in the database table 90 represents or is associated with random bits or bytes. The hashing algorithm 58 and/or the accumulator algorithm may thus randomly shuffle the Merkle value 75 and/or the Merkle root 77 as a further security operation.

Exemplary embodiments may discourage or deter specialized hardware in blockchain mining. The miner system 22, the network server 28, and/or the accumulator device 79 may be required to access to the database table 90 in order to execute the bit shuffle operation 92, the hashing algorithm 58, the difficulty algorithm 48, the accumulator algorithm, and/or the proof-of-work algorithm 52. Because any processing component (e.g., ASIC, GPU, or the CPU 36) is unable to cache the entire database table 90, exemplary embodiments force the processing component to query the processor cache memory 100 and/or the main/host memory device 38 and to await data retrieval. The hardware processing component must therefore sit, perhaps mostly idle, while the processor cache memory 100 and/or the main/host memory device 38 processes, retrieves, and sends different segments/portions/blocks of the database table 90. A faster GPU/ASIC will thus not improve memory access times/speeds. Exemplary embodiments thus force miners to choose the CPU 36, as a faster GPU/ASIC provides no performance/speed gain. Moreover, because a faster GPU/ASIC is ineffective, the extra capital expense of a faster GPU/ASIC offers little or no benefit and cannot be justified. Exemplary embodiments thus bind miners to the CPU 36 for blockchain processing/mining.

Exemplary embodiments thus include RAM hashing. The electronic database table 90 may have a random number of columns and/or a random number of rows. The electronic database table 90 may have a random number of database entries 94. Moreover, each columnar/row database entry 94 may also have a random sequence or selection of bits/bytes (1′s and 0′s). So, whatever the Merkle value(s) 75 and/or the Merkle root 77, the electronic database table 90 may be queried to further randomize the Merkle value(s) 75 and/or the Merkle root 77 for additional cryptographic security. Indeed, because only at least a portion of the electronic database table 90 may be stored in the processor cache memory 100, exemplary embodiments effectively confine hashing operations to the main/host memory device 38 (such as a subsystem RAM). Regardless of what device or service provider executes the hashing algorithm 58 and/or the accumulator algorithm, the electronic database table 90, which is mostly or entirely stored in the main/host memory device 38, provides randomized inputs to other miners, nodes, or service providers. Operationally and functionally, then, exemplary embodiments divorce or functionally separate any hardware processing element from the hashing operation. Simply put, no matter what the performance/speed/capability of the ASIC, GPU, or the CPU 36, the database table 90 may be randomly sized to always exceed the storage capacity or cache byte size 104 of the processor cache memory 100. Hashing operations are thus reliant on cache latency, cache misses, and processor stalls when using the database table 90. The hashing operations are thus largely confined to, and performed by, the off-board or off-processor main/host memory device 38 (such as a subsystem RAM). Because the main/host memory device 38 performs most or all of the cryptographic security, the hardware processing component (ASIC, GPU, or the CPU 36) may play little or no role in the hashing operations (perhaps only performing database lookup queries). Again, a better/faster ASIC or GPU provides little to no advantage in the hashing operations. Moreover, the main/host memory device 38 consumes much less electrical power, thus further providing reduced energy costs that deter/resist ASIC/GPU usage.

Exemplary embodiments may also add cryptographic security. Exemplary embodiments may force the miner/network to possess, or have authorized access to, the database table 90. In simple words, exemplary embodiments may swap random bytes in the Merkle value(s) 75 and/or the Merkle root with other random bytes specified by the database table 90. Any node, machine, or party that provides or determines a validation or proof-of-work must possess (or have access to) the database table 90. Should a miner, server, accumulator, or other machine lack authorized access to the database table 90, then the miner, server, accumulator, or other machine cannot query the database table 90 nor perform database lookup operations. Validation, difficulty, and/or proof-of-work will fail without having access to the database table 90.

Exemplary embodiments may also separately specify the difficulty algorithm 48. The proof-of-work target scheme 34 may cause the miner system 22 to apply the bit shuffle operation 92 to the hash value 64. The proof-of-work target scheme 34 may also specify the difficulty algorithm 48 and the target difficulty 84, perhaps having a high number or value. Because these byte accesses to the processor cache memory 100 are random and over a gigabyte of the memory space, the byte accesses blow or exceed the retrieval and/or byte size storage capabilities of the processor cache memory 100. The proof-of-work target scheme 34 thus forces the miner system 22 to wait on the slower main/host memory device 38 (rather than waiting on the speed of the hardware processing component). A faster/better hardware processing element (such as an ASIC), in other words, does not alleviate the bottleneck of accessing the main/host memory device 38. Moreover, because exemplary embodiments may heavily rely on the main/host memory device 38 (rather than the hardware processing component) to do proof of work, the miner system 22 consumes significantly less of electrical power (supplied by a power supply 110). Because the proof-of-work algorithm 52 and the difficulty algorithm 48 may be separate from the cryptographic hashing algorithm 58, exemplary embodiments utilize the security of a well-tested hashing function, but exemplary embodiments also require the proof-of-work scheme to use the main/host memory device 38, which makes it unreasonable to build ASICS.

Exemplary embodiments may thus force usage of a particular physical memory. Exemplary embodiments, for example, may overload the processor cache memory 100 by gorging the byte size of the database table 90 with additional database entries. Even as L1, L2, and L3 processor cache memory 100 increases in the storage capacity or byte size 104, exemplary embodiments may concomitantly increase the table byte size 102 (in bits/bytes) to ensure the database table 90 continues to exceeds the storage capacity or byte size 104 of the processor cache memory 100. Exemplary embodiments may thus bind the encryption algorithm 46, the difficulty algorithm 48, and/or the proof-of-work algorithm 52 to the main/host memory device 38 to deter GPU/ASIC usage.

Exemplary embodiments may also unbind the hashing algorithm 58 from the difficulty algorithm 48. Exemplary embodiments easily validate the proof-of-work by changing how proof-of-work is calculated without changing the hashing algorithm 58. Because the hashing algorithm 58 is disassociated or disconnected from the difficulty algorithm 48, the cryptographically security of the hashing algorithm 58 is increased or improved. Moreover, the separate difficulty algorithm 48 and/or proof-of-work algorithm 52 may have other/different objectives, without compromising the cryptographically security of the hashing algorithm 58. The difficulty algorithm 48 and/or proof-of-work algorithm 52, for example, may be designed for less consumption of the electrical power. The difficulty algorithm 48 and/or proof-of-work algorithm 52 may additionally or alternatively be designed to deter/resist ASIC/GPU usage, such as increased usage of the processor cache memory 100 and/or the main/host memory device 38. The difficulty algorithm 48 and/or proof-of-work algorithm 52 need not be cryptographically secure. Because the hashing algorithm 58 ensures the cryptographically security, the difficulty algorithm 48 and/or proof-of-work algorithm 52 need not be burdened with providing the cryptographically security. The difficulty algorithm 48 and/or proof-of-work algorithm 52 each require less programming code and less storage space/usage in bytes, so each is much simpler to code and much faster to execute.

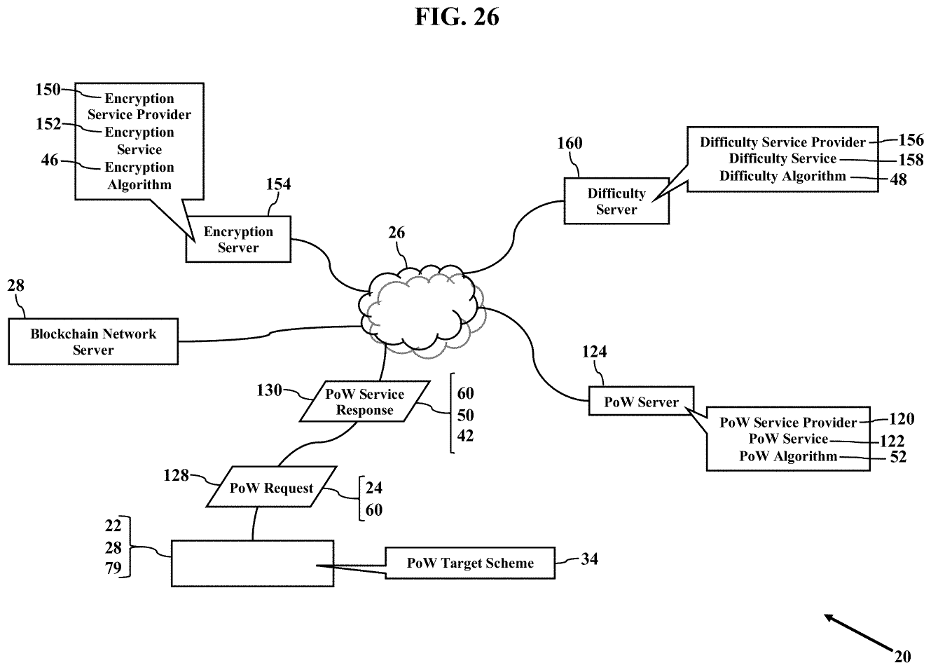

FIG. 26 illustrates vendor processing, according to exemplary embodiments. The miner system 22, the network server 28, and/or the accumulator device 79 may communicate with one or more service providers via the communications network 26. The miner system 22, the network server 28, and/or the accumulator device 79 may enlist or request that any of the service providers provide or perform a processing service. An encryption service provider 150, for example, may provide an encryption service 152 by instructing an encryption server 154 to execute the encryption algorithm 46 chosen or specified by the miner system 22, the network server 28, and/or the accumulator device 79. A difficulty service provider 156 may provide a difficulty service 158 by instructing a difficulty server 160 to execute the difficulty algorithm 48 chosen or specified by the miner system 22, the network server 28, and/or the accumulator device 79. The proof-of-work (PoW) service provider 120 (e.g., the PoW server 124) may provide the PoW service 122 by executing the proof-of-work algorithm 52 chosen or specified by the miner system 22, the network server 28, and/or the accumulator device 79. The miner system 22, the network server 28, and/or the accumulator device 79 may thus outsource or subcontract any of the encryption algorithm 46, the difficulty algorithm 48, and/or the proof-of-work algorithm 52 to the service provider(s). Because the encryption algorithm 46, the difficulty algorithm 48, and/or the proof-of-work algorithm 52 may be separate software mechanisms or packages, the service providers 150, 156, and 120 may specialize in their respective algorithms 46, 48, and 52 and/or services 152, 158, and 122. The encryption service provider 150, for example, may offer a selection of different encryption services 152 and/or encryption algorithms 46, with each encryption service 152 and/or encryption algorithm 46 tailored to a specific encryption need or feature. The difficulty service provider 156 may offer a selection of different difficulty services 158 and/or difficulty algorithms 48 that are tailored to a specific difficulty need or feature. The PoW service provider 120 may offer a selection of different PoW services 122 and/or PoW algorithms 52 that are tailored to a specific proof-of-work need or feature. The miner system 22, the network server 28, the accumulator device 79, and/or the proof-of-work (“PoW”) target scheme 34 may thus mix-and-match encryption, difficulty, and proof-of-work options.

Exemplary embodiments may thus decouple encryption, difficulty, and proof-of-work efforts. Because the encryption algorithm 46 may be a stand-alone software offering or module, exemplary embodiments greatly improve encryption security. The encryption algorithm 46 (such as the hashing algorithm 58) need not intertwine with the difficulty algorithm 48 and/or the proof-of-work algorithm 52. Because the hashing algorithm 58 may be functionally divorced from difficulty and proof-of-work calculations, the hashing algorithm 58 remains a safe, secure, and proven cryptology scheme without exposure to software bugs and errors introduced by difficulty and proof-of-work needs. The difficulty algorithm 48 may also be severed or isolated from encryption and proof-of-work, thus allowing a blockchain scheme to dynamically alter or vary different difficulty calculations without affecting encryption and/or proof-of-work. The proof-of-work algorithm 52 may also be partitioned, split off, or disconnected from encryption and difficulty, thus allowing any blockchain scheme to dynamically alter or vary different proof-of-work calculations or schemes without affecting encryption and/or difficulty.

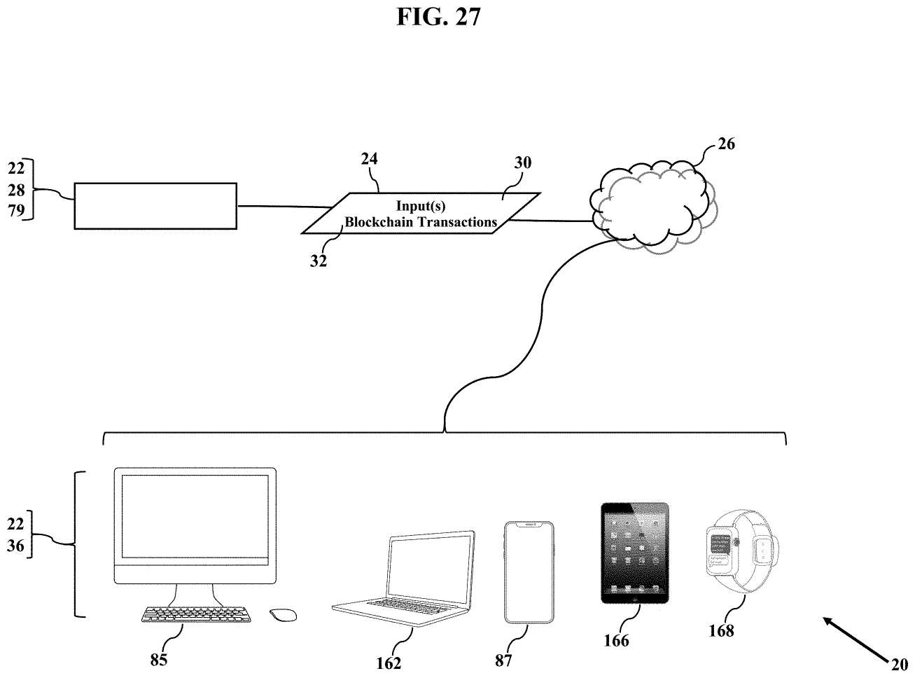

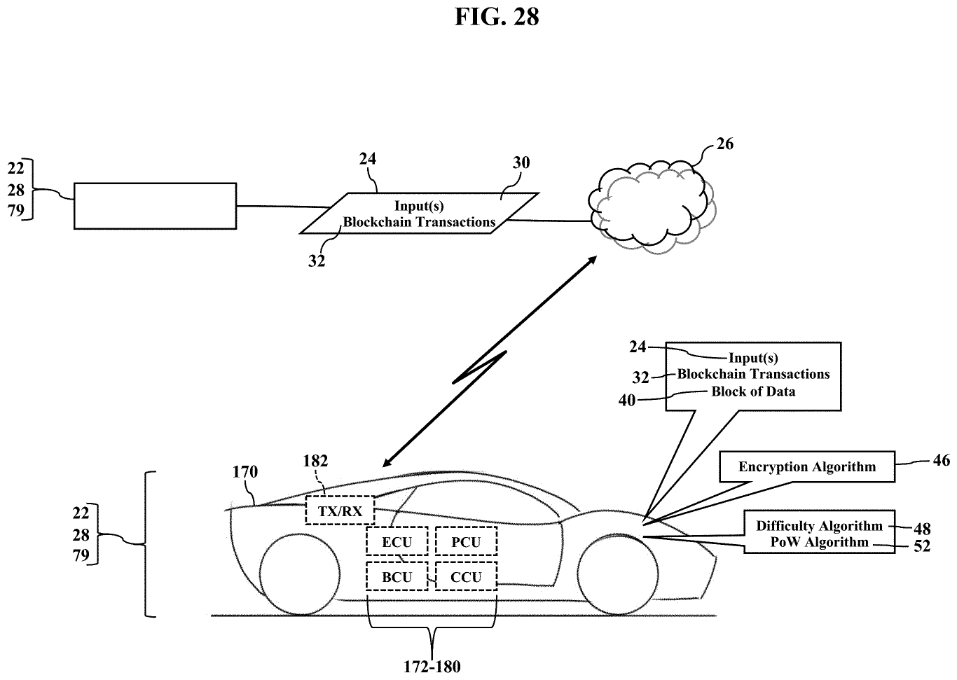

FIGS. 27-28 illustrate democratic mining, according to exemplary embodiments. As this disclosure above explains, exemplary embodiments reduce or even eliminate the need for graphics processors and specialized application-specific integrated circuits. The miner system 22, the network server 28, and/or the accumulator device 79 may thus rely on a conventional central processing unit (such as the CPU 36) to process the blockchain transactions 32. The miner system 22, the network server 28, and/or the accumulator device 79 may thus be the conventional home or business server/desktop 85 or laptop computer 162 that is much cheaper to purchase, use, and maintain. Moreover, the miner system 22, the network server 28, and/or the accumulator device 79 may even be the smartphone 87, tablet computer 166, or smartwatch 168, as these devices also have adequate processing and memory capabilities to realistically mine and win the block 40 of data (illustrated in FIGS. 1-10). Indeed, the miner system 22, the network server 28, and/or the accumulator device 79 may be any network-connected device, as exemplary embodiments reduce or even eliminate the need for specialized hardware processors. The miner system 22, the network server 28, and/or the accumulator device 79 thus opens-up blockchain mining to any network-connected appliance (e.g., refrigerator, washer, dryer), smart television, camera, smart thermostat, or other Internet of Thing.

FIG. 28 also illustrates democratic mining. Because exemplary embodiments reduce or even eliminate the need for graphics processors and specialized application-specific integrated circuits, the miner system 22, the network server 28, and/or the accumulator device 79 may even be a car, truck, or other vehicle 170. As the reader may realize, the vehicle 170 may have many electronic systems controlling many components and systems. For example, the engine may have an engine electronic control unit or “ECU” 172, the transmission may have a powertrain electronic control unit or “PCU” 174, the braking system may have a brake electronic control unit or “BCU” 176, and the chassis system may have a chassis electronic control unit or “CUC” 178. There may be many more electronic control units throughout the vehicle 170. A controller area network 180 thus allows all the various electronic control units to communicate with each other (via messages sent/received via a CAN bus). All these controllers may also interface with the communications network 26 via a wireless vehicle transceiver 182 (illustrated as “TX/RX”). The vehicle 170 may thus communicate with the miner system 22, the network server 28, and/or the accumulator device 79 to receive the inputs 24 (such as the blockchain transactions 32). The vehicle 170 may then use the various controllers 172-178 to mine/validate the blockchain transactions 32 using the encryption algorithm 46, the difficulty algorithm 48, and/or the PoW algorithm 52 (as this disclosure above explains). The reader may immediately see that the vehicle 170 is a powerful processing platform for blockchain mining. The vehicle 170 may mine the blockchain transactions 32 when moving or stationary, as long as electrical power is available to the various controllers 172-178 and to the vehicle transceiver 182. Indeed, even when parked with the ignition/battery/systems on or off, exemplary embodiments may maintain the electrical power to mine the blockchain transactions 32. So, a driver/user may configure the vehicle 17 to mine/validate the blockchain transactions 32, even when the vehicle sits during work hours, sleep hours, shopping hours, and other times of idle use. The reader may also immediately see that vehicular mining opens up countless additional possibilities to win the block 40 of data (i.e., solve the problem or puzzle 54) without additional investment in mining rigs. Thousands, millions, or even billions of vehicles 170 (e.g., cars, trucks, boats, planes, buses, trains, motorcycles) may mine the blockchain transactions 32, thus providing a potential windfall to offset the purchasing and operational expenses.

Exemplary embodiments reduce energy consumption. Because a conventional, general purpose central processing unit (e.g., the CPU 36) is adequate for mining the blockchain transactions 32, exemplary embodiments consume much less electrical power. Moreover, because a conventional central processing unit consumes much less electrical power, the CPU operates at much cooler temperatures, generates less waste heat/energy, and therefore requires less cooling, air conditioning, and refrigerant machinery. Exemplary embodiments are thus much cheaper to operate than GPUs and ASICs.

Exemplary embodiments thus democratize blockchain mining. Because encryption, difficulty, and proof-of-work efforts may be functionally divided, general-purpose computer equipment has the processing and memory capability to compete as blockchain miners. For example, because the function(s) that calculate(s) the magnitude of the proof of work (such as the difficulty algorithm 48 and/or the proof-of-work algorithm 52) may be detached or isolated from the function that performs cryptography (such as the hashing algorithm 58), encryption need not be modified in order to improve security (e.g., such as the MONERO® mining scheme). The well-tested SHA-256 hashing function, for example, remains stable and unaffected by difficulty and/or proof-of-work. The difficulty algorithm 48, in other words, need not be determined by or with the hashing algorithm 58. The difficulty algorithm 48, instead, may be separately determined as a true, independent measure of the difficulty 50. The inventor has realized that most or all proof of work schemes generally may have two functions (i.e., one function to do a cryptographic hash and another function to determine the level of difficulty of a given hash). Exemplary embodiments may separate, or take away, what makes proof of work hard from the cryptographic hash and, perhaps instead, put it in the difficulty algorithm 48 that calculates which hash is more difficult. The difficulty algorithm 48, for example, may be functionally combined with the proof-of-work algorithm 52 that calculates the magnitude of the proof of work instead of using the hashing algorithm 58 (as FIG. 5 illustrates). Exemplary embodiments need not try to design, develop, or modify hashing functions that deter ASIC mining.

Encryption may thus be independent from proof-of-work determinations. The proof of work (such as the difficulty algorithm 48 and/or the proof-of-work algorithm 52) may be a different or separate software mechanism from the hashing mechanism. The difficulty 50 of the proof-of-work, for example, may be a separate component from staking in a blockchain. The difficulty algorithm 48 and/or the proof-of-work algorithm 52 may require communications networking between provably different parties. The difficulty algorithm 48 and/or the proof-of-work algorithm 52 may require network delays and/or memory bandwidth limitations. The difficulty algorithm 48 and/or the proof-of-work algorithm 52 may have a random component (such as incorporating a random function), such that the difficulty algorithm 48 and/or the proof-of-work algorithm 52 may randomly to determine the difficulty 50 and/or the proof-of-work result 42. Exemplary embodiments thus reduce or even eliminate the power intensive mechanism that is inherent in today's proof of work schemes by changing how the proof of work is calculated. Exemplary embodiments need not change the hashing algorithm 58, and exemplary embodiments allow a more easily validated proof of work. The hashing algorithm 58 is not bound or required to determine the proof of work. The proof of work need not be cryptographically secure. The liberated, autonomous hashing algorithm 58 generates and guarantees an input (e.g., the hash values 64) that cannot be predicted by some other faster algorithm. The disassociated hashing algorithm 58 effectively generates the hash values 64 as random numbers. The hashing algorithm 58, in other words, provides cryptographic security, so neither the difficulty algorithm 48 nor the proof-of-work algorithm 52 need be cryptographically secure. The difficulty algorithm 48 and/or the proof-of-work algorithm 52 need not be folded into the hashing algorithm 58.

Exemplary embodiments provide great value to blockchains. Exemplary embodiments may functionally separate encryption (e.g., the hashing algorithm 58) from proof of work (such as the difficulty algorithm 48 and/or the proof-of-work algorithm 52). Exemplary embodiments may thus bind proof-of-work to a conventional central processing unit. Deploying a different cryptographic hash is hugely dangerous for blockchains, but deploying another difficulty or proof of work mechanism is not so dangerous. Exemplary embodiments allow blockchains to experiment with different difficulty functions (the difficulty algorithms 48) and/or different proof-of-work algorithms 52 without changing the hashing algorithm 58. Exemplary embodiments thus mitigate risk and reduce problems with cryptographic security. Many blockchain environments would prefer to make their technology CPU mineable for lower power, lower costs, and more democratic participation. The barrier, though, is that conventionally these goals would require changing their hash function. Exemplary embodiments, instead, reduce costs and increase the pool of miner systems without changing the hash function. The difficulty algorithm 48 and/or the proof-of-work algorithm 52 may be refined, modified, or even replaced with little or no impact on the hashing algorithm 58.

Exemplary embodiments reduce electrical power consumption. Blockchain mining is very competitive, as the first miner that solves the mathematical puzzle 54 owns the block 40 of data and is financially rewarded. Large “farms” have thus overtaken blockchain mining, with each miner installation using hundreds or even thousands of ASIC-based computers to improve their chances of first solving the calculations specified by the mathematical puzzle 54. ASIC-based blockchain mining requires tremendous energy resources, though, with some studies estimating that each BITCOIN® transaction consumes more daily electricity than an average American home. Moreover, because ASIC-based blockchain mining operates 24/7/365 at full processing power, the ASIC-based machines quickly wear out or fail and need periodic (perhaps yearly) replacement. Exemplary embodiments, instead, retarget blockchain mining back to CPU-based machines that consume far less electrical power and that cost far less money to purchase. Because the capital costs and expenses are greatly reduced, more miners and more CPU-based machines may effectively participate and compete. The CPU-based machines, in other words, have a realistic and profitable chance of first solving the calculations specified by the mathematical puzzle 54. Democratic participation is greatly increased.

Smart, digital contracts are also simplified. As the reader may understand, the blockchain environment 20 and/or the blockchain 56 may reference a digital contract. The digital contract is a software program that adds one or more layers of information onto the digital blockchain transactions 32 being executed by or on the blockchain 56. The digital contract is sometimes referred to as a self-executing or “smart” contract between parties to a transaction. When the digital contract is executed, the parties to the digital contract may be compensated. While there are many compensation schemes, most readers are perhaps familiar with crypto-compensation. That is, when the digital contract successfully executes, perhaps the parties exchange, trade, or transfer one or more currencies, cryptographic tokens/coinage, or other compensation. When any party, or all the parties, perform their assigned role in the transaction, value is given or exchanged.

The digital contract is thus a computer program or code that verifies and/or enforces negotiation and/or performance of a contract between parties. One fundamental purpose of so-called smart contracts is to integrate the practice of contract law and related business practices with electronic commerce protocols between parties or devices via the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others. Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

The digital contract may also be identified. The blockchain environment 20, the blockchain 56, the blockchain network server 28, the miner system 22, and/or the accumulator device 79 may include or reference the digital contract as informational content. For example, the digital contract may be identified by a contract identifier and contractual information. The contract identifier is any digital identifying information that uniquely identifies or references the digital contract. The contract identifier may be an alphanumeric combination that uniquely identifies a vendor and/or version of the digital contract and/or a processor or executioner of the digital contract. The contract identifier may also be a hash value (perhaps generated by a hashing algorithm) that is included within, or specified by, the blockchain environment 20 and/or the blockchain 56. Similarly, the contractual information may identify the parties to the digital contract, their respective performance obligations and terms, and consideration.

Smart contracts may be processed. The blockchain environment 20, the blockchain 56, the blockchain network server 28, the miner system 22, and/or the accumulator device 79 may outsource an execution of the smart contract to a contract server. The contract server may represent a vendor, supplier, or service as a subcontractor process. The blockchain environment 20, the blockchain 56, the blockchain network server 28, the miner system 22, and/or the accumulator device 79 receives the blockchain 56 sent from any entity. The blockchain environment 20, the blockchain 56, the blockchain network server 28, the miner system 22, and/or the accumulator device 79 inspects the blockchain 56 to identify the contract identifier and/or any contractual parameters associated with the digital contract. The contract identifier may be used to identify a destination, network address, server, or other processing component that processes the digital contract (such as the contract server), perhaps according to the contractual parameters.

The randomized Merkle values may also be sent. The smart contract may have programming code that references blockchain transactions 32. The contractual parameters, for example, may specify data or information associated with the blockchain transactions 32. Conventional smart contract schemes, for example, may require the actual blockchain transactions 32 associated with the block 40 of data. Conventional smart contract schemes may thus distribute hundreds, thousands, or even more of the blockchain transactions 32, or the entire block 40 of data, for executing the smart contract. Exemplary embodiments, instead, may merely send the randomized Merkle values representing the validated data. Any of the randomized Merkle values may thus be quickly and simply conveyed via the communications network 26, without downloading and sending the individual blockchain transactions 32, the block 40 of data, and/or larger portions of the blockchain 56. In other words, only small byte portions need be stored and downloaded, which consumes far less memory byte space and requires far less processor time/tasks/cycles/operations. Moreover, because only small byte portions need be packetized, the number of IP packets in the communications network 26 is reduced, so network traffic is reduced.

Once the contract server is identified, a service request may be sent to the contract server. The service request requests that the contract server execute the digital contract, based on the contract identifier, the contractual parameters, and/or the randomized Merkle values. The service request may thus specify the contract identifier, the contractual parameters, and/or the randomized Merkle values as inputs for remote, off-chain execution of the digital contract. The contract server applies the inputs to the programming code representing the digital contract. Once the digital contract is executed, the contract server may then return send a contractual service response comprising data or information describing an outcome of the digital contract based on the supplied inputs (such as consideration, payment, or performance terms). The blockchain environment 20, the blockchain 56, the blockchain network server 28, the miner system 22, and/or the accumulator device 79 may thus add entries to the electronic database 81 that log the service request and/or the service response in association with the digital contract, the contract identifier, the contractual parameters, the randomized Merkle values, the transaction 32, and other data.

Exemplary embodiments may thus pool validation efforts. Conventional blockchain processing schemes distribute hundreds, thousands, or even more of the blockchain transactions 32, or the entire block 40 of data, throughout the blockchain environment 20. Significant byte memory is required to store these voluminous blockchain transactions 32. Moreover, these hundreds, thousands, or more blockchain transactions 32 inject many additional network packets into the communications network 26, thus contributing to network congestion, delay, and jitter. Exemplary embodiments, instead, may merely send the needed Merkle values 75 (and/or their representative bit-shuffled randomized values). The Merkle values 75 may thus be quickly and simply conveyed via the communications network 26, thus consuming much less memory byte space, much less processor time/tasks/cycles/operations, and much less electrical power. Moreover, because only small byte portions (representing the Merkle values 75) need be packetized, the number of IP packets in the communications network 26 is reduced, so network traffic, delay, and jitter is reduced.

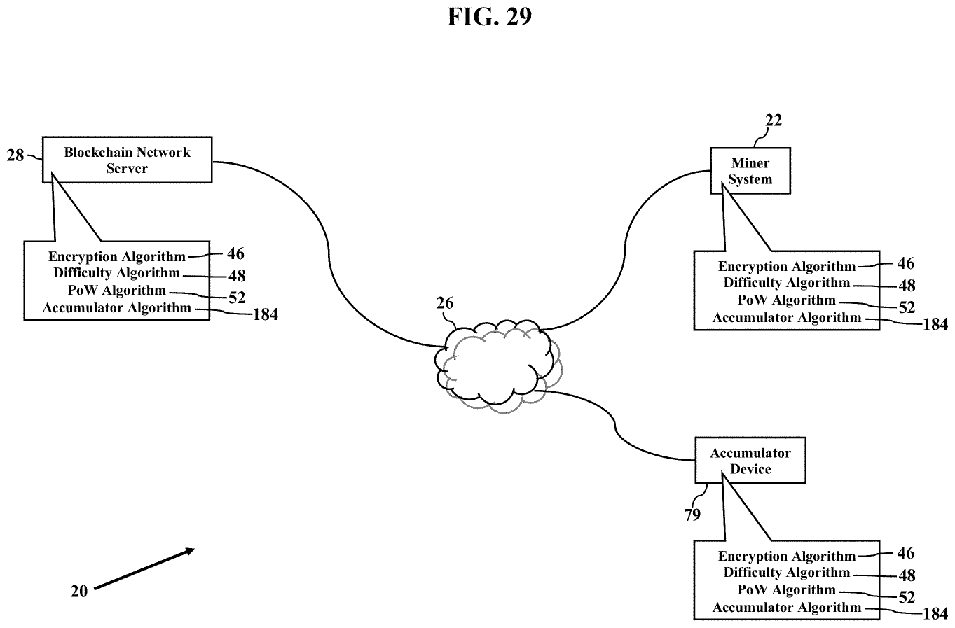

FIG. 29 is a more detailed illustrations of an operating environment, according to exemplary embodiments. FIG. 29 illustrates the miner system 22, the blockchain network server 28, and the accumulator device 79 communicating via the communications network 26 (perhaps by specifying a unique network IP address). While the miner system 22, the blockchain network server 28, and the accumulator device 79 may functionally operate as a single device/server, separate networking components are believed easier to understand. The miner system 22, the blockchain network server 28, and the accumulator device 79 operate in the blockchain environment 20. The miner system 22, the blockchain network server 28, and the accumulator device 79 have a hardware processing component (such as the CPU 36) that executes the encryption algorithm 46, the difficulty algorithm 48, the PoW algorithm 52, and/or the accumulator algorithm 184 stored in a local memory device (such as the memory device 38 illustrated in FIG. 25). The miner system 22, the blockchain network server 28, and the accumulator device 79 have a network interface to the communications network 26, thus allowing two-way, bidirectional communication with each other. The encryption algorithm 46, the difficulty algorithm 48, the PoW algorithm 52, and/or the accumulator algorithm 184 include instructions, code, and/or programs that cause the miner system 22, the blockchain network server 28, and/or the accumulator device 79 to perform operations, such as sending the inputs 24 (such as the blockchain transactions 32), randomizing the Merkle values 75, and/or executing other validation processes, as the above paragraphs explain.

Exemplary embodiments may be applied regardless of networking environment. Exemplary embodiments may be easily adapted to stationary or mobile devices having wide-area networking (e.g., 4G/LTE/5G cellular), wireless local area networking (WI-FI®), near field, and/or BLUETOOTH® capability. Exemplary embodiments may be applied to stationary or mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. For example, the miner system 22, the blockchain network server 28, and the accumulator device 79 may utilize any desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or any other manufacturer. The miner system 22, the blockchain network server 28, and the accumulator device 79 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

Exemplary embodiments may packetize. When the miner system 22, the blockchain network server 28, and the accumulator device 79 communicate via the communications network 26, the miner system 22, the blockchain network server 28, and the accumulator device 79 may collect, send, and retrieve information. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

Exemplary embodiments may use any encryption or hashing function. There are many encryption algorithms and schemes, and exemplary embodiments may be adapted to execute or to conform to any encryption algorithm and/or scheme. In the blockchain environment 20, though, many readers may be familiar with the various hashing algorithms, especially the well-known SHA-256 hashing algorithm. The SHA-256 hashing algorithm acts on any electronic data or information to generate a 256-bit hash value as a cryptographic key. The key is thus a unique digital signature. However, there are many different hashing algorithms, and exemplary embodiments may be adapted to execute or to conform to any hashing algorithm, hashing family, and/or hashing scheme (e.g., Blake family, MD family, RIPE family, SHA family, CRC family).

The miner system 22, the blockchain network server 28, and the accumulator device 79 may store or request different software packages. The hashing algorithm 58 may be a software file, executable program, routine, module, programming code, or third-party service that hashes the blockchain transactions 32 to generate the hash value(s) 64. The difficulty algorithm 48 may be a software file, executable program, routine, module, programming code, or third-party service that uses the hash value(s) 64 to generate the difficulty 50. The proof-of-work (“PoW”) algorithm 52 be a software file, executable program, routine, module, programming code, or third-party service that uses the hash value(s) 64 to generate the PoW result 42. The miner system 22, the blockchain network server 28, and the accumulator device 79 may download or otherwise acquire the hashing algorithm 58, the difficulty algorithm 48, and/or the PoW algorithm 52 to provide mining/validating operations for the blockchain transactions 32.

The blockchain environment 20 may flexibly switch or interchange encryption, difficulty, and proof-of-work. Because the hashing algorithm 58, the difficulty algorithm 48, and the proof-of-work algorithm 52 may be separate software packages, the proof-of-work (“PoW”) target scheme 34 and/or the blockchain environment 20 may mix-and-match the encryption algorithm 46, the difficulty algorithm 48, and the proof-of-work algorithm 52. The blockchain environment 20 may thus easily evaluate different combinations of the encryption algorithm 46, the difficulty algorithm 48, and the proof-of-work algorithm 52 with little or no intra-algorithm or intra-application effect. The blockchain environment 20 may mix-and-match encryption, difficulty, and proof-of-work.

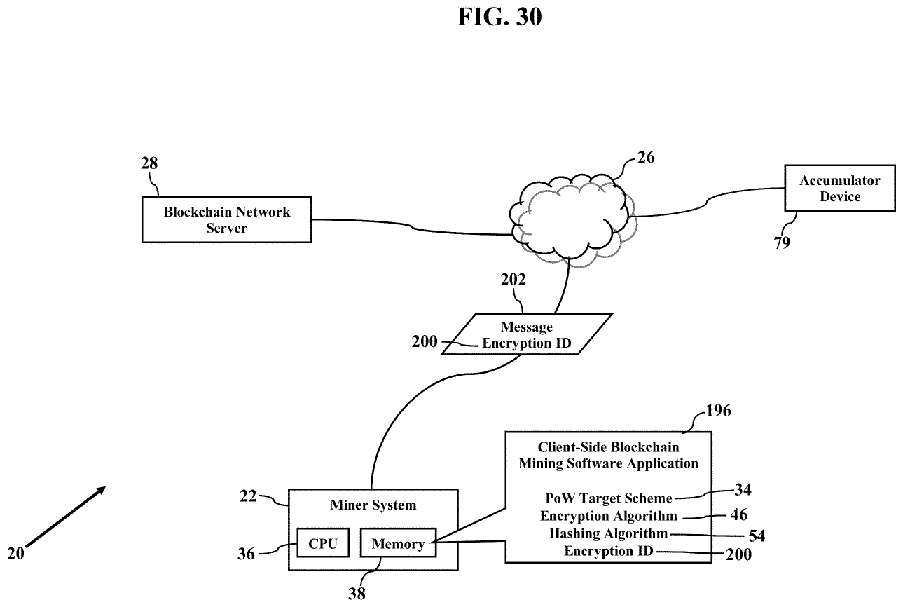

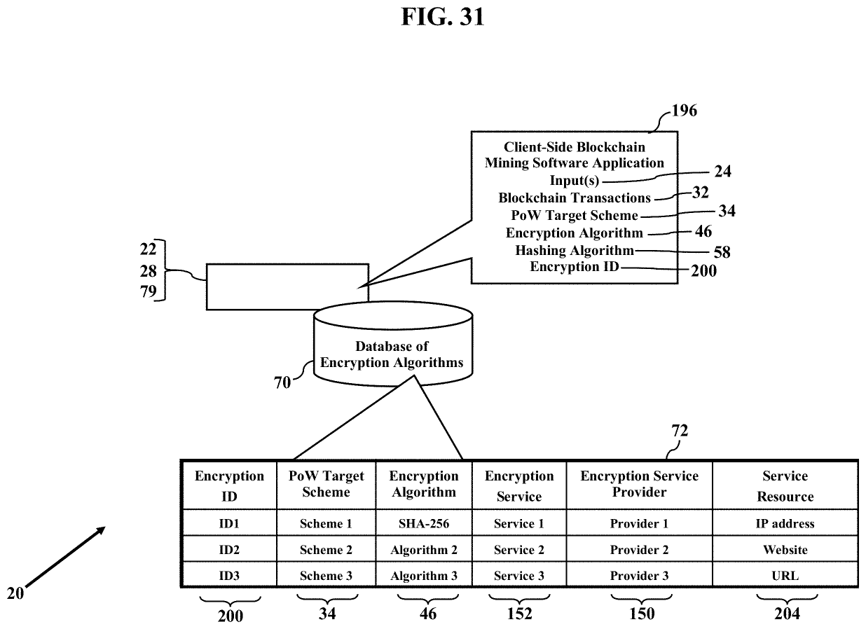

FIGS. 30-31 illustrate validation specifications, according to exemplary embodiments. When the miner system 22 communicates with the blockchain network server 28 and/or the accumulator device 79, the blockchain environment 20 may specify the hashing algorithm 58, the difficulty algorithm 48, and the proof-of-work algorithm 52 (the proof-of-work (“PoW”) target scheme 34) that is required by the blockchain environment 20. That is, when the miner system 22 participates as a miner and mines or processes blockchain records/transactions, the miner system 22 may be required or instructed to use the particular hashing algorithm 58, the difficulty algorithm 48, and/or the proof-of-work algorithm 52 specified by the blockchain network. For example, in order for the miner system 22 to be authorized or recognized as a mining participant, the miner system 22 may be required to download a client-side blockchain mining software application 196 that specifies or includes the hashing algorithm 58, the difficulty algorithm 48, and/or the proof-of-work algorithm 52. The client-side blockchain mining software application 196 may thus comprise any software apps or modules, files, programming code, or instructions representing the hashing algorithm 58, the difficulty algorithm 48, and/or the proof-of-work algorithm 52.

An encryption identifier mechanism may be used. In order to reduce a memory byte size and/or programming line size of the PoW target scheme 34 and/or the client-side blockchain mining software application, exemplary embodiments may specify an encryption identifier (encryption “ID”) 200 associated with the blockchain network's chosen or required encryption scheme. The encryption identifier 200 may be any alphanumeric combination, hash value, network address, website, or other data/information that uniquely identifies the PoW target scheme 34 and/or the encryption algorithm 46 used by the blockchain environment 20. The miner system 22 may receive the encryption identifier 200 as a specification or parameter associated with the PoW target scheme 34 and/or the encryption algorithm 46. The miner system 22 may additionally or alternatively receive a packetized message (perhaps from the blockchain network server 28 or the accumulator device 79), and a packet header and/or payload may specify or include the encryption identifier 200 as a data field, specification, or parameter. Again, because many or most blockchain networks use hashing as an encryption mechanism, the encryption identifier may specify, be assigned to, or be associated with the hashing algorithm 58. The blockchain network server 28 or the accumulator device 79 may thus send the encryption identifier (via the communications network 26) to the miner system 22. The encryption identifier 200 may be packaged as a downloadable component, parameter, or value with the client-side blockchain mining software application. However, the encryption identifier 200 may additionally or alternatively be sent to the miner system 22 at any time via the message. Because the encryption identifier 200 may be separately sent from the client-side blockchain mining software application 196, the encryption identifier 200 may be dynamically updated or changed without downloading a new or updated client-side blockchain mining software application 196.

As FIG. 31 illustrates, exemplary embodiments may consult the electronic database 70 of encryption algorithms. Once the blockchain environment 20 specifies the encryption identifier 200, the miner system 22 may implement the encryption scheme represented by the encryption identifier 200. The miner system 22 may obtain, read, or retrieve the encryption identifier 200 specified by the client-side blockchain mining software application 196 and/or packet inspect the message 202. Once the encryption identifier 200 is determined, the miner system 22 may identify the corresponding blockchain encryption scheme by querying the electronic database 70 of encryption algorithms for the encryption identifier 200. FIG. 31 illustrates the electronic database 70 of encryption algorithms locally stored in the memory device 38 of the miner system 22. The electronic database 70 of encryption algorithms may store, reference, or associate the encryption identifier 200 to its corresponding proof-of-work target scheme 34 and/or encryption algorithm 46. The miner system 22 may thus perform or execute a database lookup for the encryption identifier 200 to identify which proof-of-work target scheme 34 and/or encryption algorithm 46 is required for miners operating in the blockchain environment 20. The miner system 22 may then retrieve, call, and/or execute the encryption algorithm 46 using the inputs 24 (such as the blockchain transactions 32), as this disclosure above explained (with reference to FIG. 7).

Exemplary embodiments may outsource encryption operations. When the miner system 22 determines the encryption identifier 200, the corresponding blockchain encryption scheme may require or specify the encryption service provider 150 that provides the encryption service 152. As FIG. 31 also illustrates, the electronic database 70 of encryption algorithms may map or relate the encryption identifier 200 to its corresponding encryption service provider 150 that provides the encryption service 152. The miner system 22 may thus identify an encryption service resource 204 that provides the encryption service 152. The encryption service resource 204, for example, may be an Internet protocol address, website/webpage, and/or uniform resource locator (URL) that is assigned to, or associated with, the encryption service provider 150 and/or the encryption service 152. The miner system 22 may outsource or subcontract the inputs 24 (such as the blockchain transactions 32) to the encryption service resource 204 (perhaps using the service request and service response mechanism above explained).

Exemplary embodiments may thus be agnostic to hashing. The miner system 22 may call, request, and/or execute any encryption scheme specified by any client, cryptographic coin, or blockchain network. The miner system 22 may dynamically switch or mix-and-match different encryption schemes. Once the miner system 22 determines the proof-of-work target scheme 34, the encryption algorithm 46, the encryption service provider 150, the encryption service 152, the encryption identifier 200, and/or the encryption service resource 204, the miner system 22 may perform any encryption scheme specified for the blockchain environment 20. The blockchain environment 20 may dynamically change the encryption scheme at any time. The blockchain environment 20 may flexibly switch, change, and evaluate different encryption strategies, perhaps with little or no impact or effect on difficulty and proof-of-work operations. Moreover, the miner system 22 may operate within or mine different blockchain environments 20 without specialized hardware rigs.

Exemplary embodiments improve computer functioning. Because exemplary embodiments may only specify the encryption identifier 200, the memory byte size consumed by the proof-of-work (“PoW”) target scheme 34 and/or the client-side blockchain mining software application 196 is reduced. That is, the blockchain network server 28 need not send the entire software program, code, or instructions representing the hashing algorithm 58 used by the blockchain environment 20. The blockchain environment 20, the blockchain network server 28, and/or the proof-of-work (“PoW”) target scheme 34 need only specify much smaller byte-sized data or information representing the encryption algorithm 46, the encryption service provider 150, the encryption service 152, the encryption identifier 200, and/or the encryption service resource 204. The blockchain environment 20 need not be burdened with conveying the hashing algorithm 58 to the miner system 22 and other mining nodes. The blockchain environment 20 and the communications network 26 convey less packet traffic, so packet travel times and network latency are reduced. Moreover, especially if the miner system 22 outsources the hashing operation, the miner system 22 is relieved from processing/executing the hashing algorithm 58 and consumes less of the electrical power. Again, then, a faster and more expensive graphics processor or even ASIC will not speed up the hashing operation. The conventional central processing unit 36 is adequate, reduces costs, and promotes democratic mining.

The blockchain environment may similarly specify a difficulty identifier mechanism. The proof-of-work (“PoW”) target scheme 34 (required by the blockchain environment 20 may specify a difficulty identifier (difficulty “ID”) 210 associated with the blockchain network's chosen or required difficulty scheme. The difficulty identifier may be any alphanumeric combination, hash value, network address, website, or other data/information that uniquely identifies the PoW target scheme 34 and/or the difficulty algorithm 48 used by the blockchain environment 20. The blockchain environment 20 may set or specify the difficulty identifier as a specification or parameter associated with the PoW target scheme 34 and/or the difficulty algorithm 48 (perhaps by distributing or sending a packetized message having a packet header and/or payload specifying or including the difficulty identifier as a data field, specification, or parameter). Because the difficulty identifier may be separately sent from the client-side blockchain mining software application 196, the difficulty identifier may be dynamically updated or changed without downloading a new or updated client-side blockchain mining software application 196. Exemplary embodiments may consult the electronic database 74 of difficulty algorithms and identify/retrieve the corresponding blockchain difficulty scheme (proof-of-work target scheme 34 and/or difficulty algorithm 48). Exemplary embodiments may further outsource difficulty operations to the difficulty service provider that provides the difficulty service. The electronic database 74 of difficulty algorithms may map or relate the difficulty identifier to its corresponding difficulty service provider that provides the difficulty service (such as an Internet protocol address, website/webpage, and/or uniform resource locator (URL) that is assigned to, or associated with, the difficulty service provider and/or the difficulty service). The miner system 22 may outsource or subcontract the hash value(s) 64 and/or the randomized Merkle values to the difficulty service resource (perhaps using the service request and service response mechanism above explained).

Exemplary embodiments may thus be agnostic to difficulty. The miner system 22 may call, request, and/or execute any difficulty scheme specified by any client, cryptographic coin, or blockchain network. The miner system 22 may dynamically switch or mix-and-match different difficulty schemes. Once the miner system 22 determines the proof-of-work target scheme 34, the difficulty algorithm 48, the difficulty service provider, the difficulty service, the difficulty identifier, and/or the difficulty service resource, the miner system 22 may perform any difficulty scheme specified for the blockchain environment 20. The blockchain environment 20 may dynamically change the difficulty scheme at any time. The blockchain environment 20 may flexibly switch, change, and evaluate different difficulty strategies, perhaps with little or no impact or effect on hashing and proof-of-work operations. Moreover, the miner system 22 may operate within or mine different blockchain environments 20 without specialized hardware rigs.

The blockchain environment may similarly specify a proof-of-work (“PoW”) identifier mechanism. In order to reduce a memory byte size and/or programming line size of the PoW target scheme 34 and/or the client-side blockchain mining software application 196, exemplary embodiments may specify a PoW identifier associated with the blockchain network's chosen or required PoW scheme. The PoW identifier may be any alphanumeric combination, hash value, network address, website, or other data/information that uniquely identifies the PoW target scheme 34 and/or the PoW algorithm 52 used by the blockchain environment 20. The miner system 22 may receive the PoW identifier as a specification or parameter associated with the PoW target scheme 34 and/or the PoW algorithm 52. The miner system 22 may receive the packetized message having a packet header and/or payload may specify or include the PoW identifier as a data field, specification, or parameter. Because the PoW identifier may be separately sent from the client-side blockchain mining software application 196, the PoW identifier may be dynamically updated or changed without downloading a new or updated client-side blockchain mining software application 196. Exemplary embodiments may consult the electronic database 78 of PoW algorithms to identify the corresponding blockchain proof-of-work scheme 34 and PoW algorithm 52.

Exemplary embodiments may outsource difficulty operations. When the miner system 22 determines the PoW identifier, the corresponding blockchain proof-of-work scheme may require or specify the PoW service provider that provides the PoW service. The electronic database 78 of PoW algorithms may map or relate the PoW identifier to its corresponding PoW service provider and PoW service. The miner system 22 may thus identify a PoW service resource that provides the PoW service 122 (such as an Internet protocol address, website/webpage, and/or uniform resource locator (URL) that is assigned to, or associated with, the PoW service provider and/or PoW service). The miner system 22 may outsource or subcontract the hash value(s) 64 or the randomized Merkle values to the PoW service resource (perhaps using the service request and service response mechanism above explained).

Exemplary embodiments may thus be agnostic to proof-of-work. The miner system 22 may call, request, and/or execute any proof-of-work scheme specified by any client, cryptographic coin, or blockchain network. The miner system 22 may dynamically switch or mix-and-match different proof-of-work schemes. Once the miner system 22 determines the proof-of-work target scheme 34, the PoW algorithm 52, the PoW service provider, the PoW service, the PoW identifier, and/or the PoW service resource, the miner system 22 may perform any proof-of-work scheme specified for the blockchain environment 20. The blockchain environment 20 may dynamically change the proof-of-work scheme at any time. The blockchain environment 20 may flexibly switch, change, and evaluate different proof-of-work strategies, perhaps with little or no impact or effect on hashing and difficulty operations. Moreover, the miner system 22 may operate within or mine different blockchain environments 20 without specialized hardware rigs.

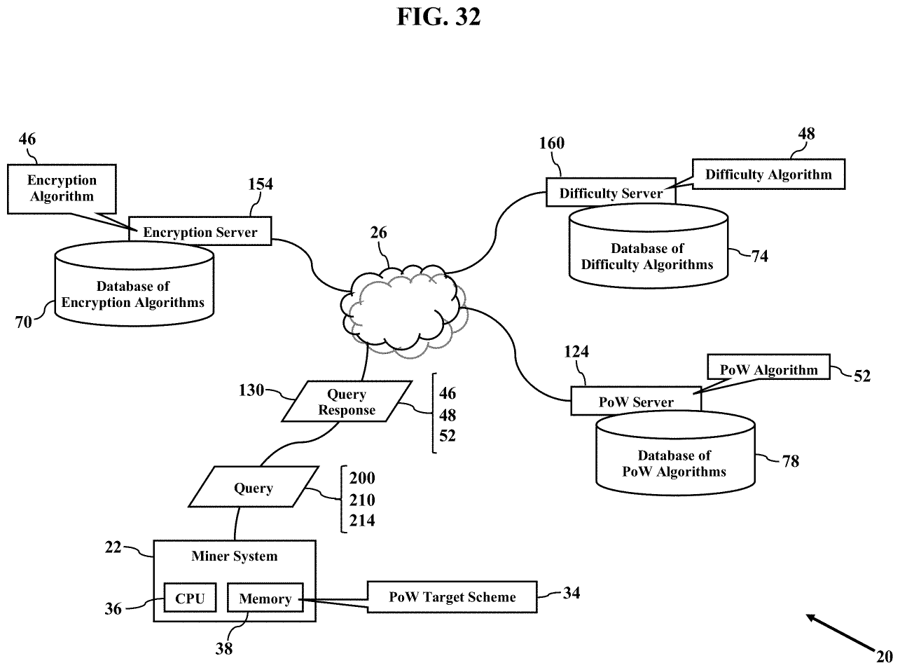

FIG. 32 illustrates remote retrieval, according to exemplary embodiments. After the miner system 22 determines the proof-of-work (“PoW”) target scheme 34 that is required by the blockchain environment 20, the miner system 22 may acquire or download the encryption algorithm 46, the difficulty algorithm 48, and/or the PoW algorithm 52. For example, the miner system 22 may determine the encryption identifier 200 (as this disclosure above explains) and send a query to the encryption server 154. The query specifies the encryption identifier 200. When the encryption server 154 receives the query, the encryption server 154 may query the database 70 of encryption algorithms for the encryption identifier 200. The encryption server 154 may locally store the database 70 of encryption algorithms and function as a networked encryption resource for clients. The encryption server 154 identifies and/or retrieves the corresponding encryption algorithm 46. The encryption server 154 sends a query response to the miner system 22, and the query response specifies or includes the corresponding encryption algorithm 46. The miner system 22 may then execute the encryption algorithm 46, as above explained.

The miner system 22 may also remotely retrieve the difficulty algorithm 48. After the miner system 22 determines the proof-of-work (“PoW”) target scheme 34 that is required by the blockchain environment 20, the miner system 22 may acquire or download the difficulty algorithm 48. For example, the miner system 22 may determine the difficulty identifier 210 (as this disclosure above explains) and send a query to the difficulty server 160. The query specifies the difficulty identifier 210. When the difficulty server 160 receives the query, the difficulty server 160 may query the database 74 of difficulty algorithms for the difficulty identifier 210. The difficulty server 160 may locally store the database 74 of difficulty algorithms and function as a networked difficulty resource for clients. The difficulty server 160 identifies and/or retrieves the corresponding difficulty algorithm 48. The difficulty server 160 sends a query response to the miner system 22, and the query response specifies or includes the corresponding difficulty algorithm 48. The miner system 22 may then execute the difficulty algorithm 48, as above explained.

The miner system 22 may remotely retrieve the PoW algorithm 52. After the miner system 22 determines the proof-of-work (“PoW”) target scheme 34 that is required by the blockchain environment 20, the miner system 22 may acquire or download the PoW algorithm 52. For example, the miner system 22 may determine the PoW identifier 214 (as this disclosure above explains) and send a query to the PoW server 124. The query specifies the PoW identifier 214. When the PoW server 124 receives the query, the PoW server 124 may query the database 78 of PoW algorithms for the PoW identifier 214. The PoW server 124 may locally store the database 78 of PoW algorithms and function as a networked proof-of-work resource for clients. The PoW server 124 identifies and/or retrieves the corresponding PoW algorithm 52. The PoW server 124 sends a query response to the miner system 22, and the query response specifies or includes the corresponding PoW algorithm 52. The miner system 22 may then execute the PoW algorithm 52, as above explained.

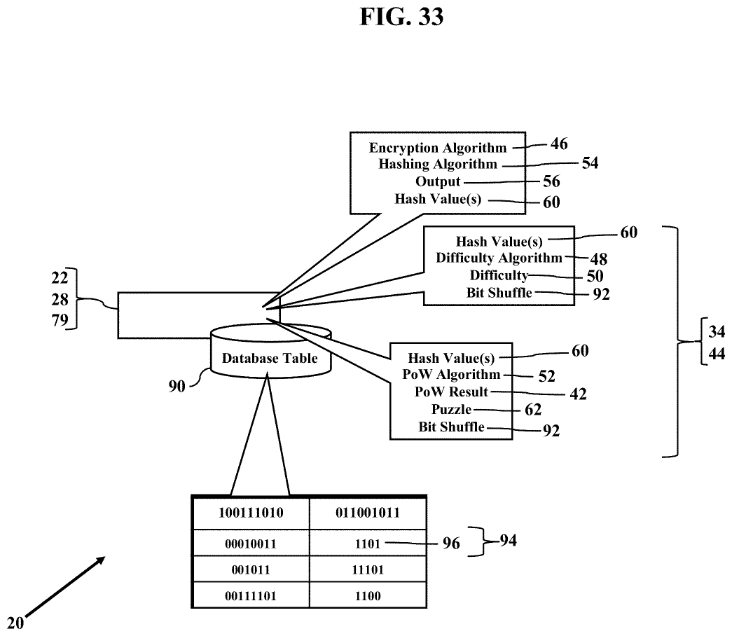

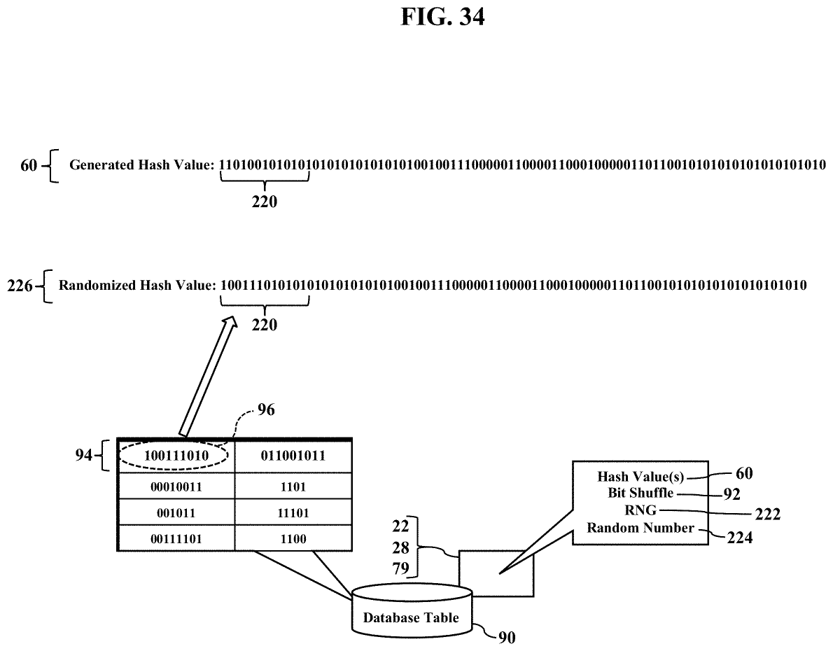

FIGS. 33-34 further illustrate the bit shuffle operation 92, according to exemplary embodiments. The difficulty algorithm 48 and/or the proof-of-work algorithm 52 may perform the bit shuffle operation 92 to conduct any difficulty and/or proof-of-work. After the hashing algorithm 58 generates the hash value(s) 64 (as this disclosure above explains), exemplary embodiments may use the database table 90 to further deter GPU/ASIC usage. The difficulty algorithm 48 and/or the proof-of-work algorithm 52 may implement the bit shuffle operation 92 on the hash value(s) 64. As FIG. 34 illustrates, suppose the hash value 64 is represented by a sequence or series of 256 bit values. The difficulty algorithm 48 and/or the proof-of-work algorithm 52 may select an arbitrary portion or number 220 of the bit values. The difficulty algorithm 48 and/or the proof-of-work algorithm 52, for example, may call, use, or execute a random number generator (RNG) 222 to generate one or more random numbers 224. As an example, a first random number 224 may be used to select a random entry 94 in the database table 90. The difficulty algorithm 48 and/or the proof-of-work algorithm 52 may then query the database table 90 for the random entry 94 and identify/retrieve the corresponding random bits 96. The difficulty algorithm 48 and/or the proof-of-work algorithm 52 may then select and replace the arbitrary portion or number 220 of the bit values in the hash value 64 with the random bits retrieved from the entry 94 in the database table 90. The bit shuffle operation 92 thus converts the hash value 64 and generates a resulting randomized hash value 226. The difficulty algorithm 48 and/or the proof-of-work algorithm 52 may instruct or cause the miner system to repeat the bit shuffle operation 92 as many times as desired. The randomized hash value 226 may, or may not, have the same number of 256 bit values. The randomized hash value 226 may have less than, or more than, 256 bit values. The randomized hash value 226 may have an arbitrary number of bit values. Once the specified or required number of bit shuffle operations 92 is complete, the difficulty algorithm 48 and/or the proof-of-work algorithm 52 may instruct or cause the miner system to determine the difficulty 50 and/or the PoW result 42 (as this disclosure above explains).

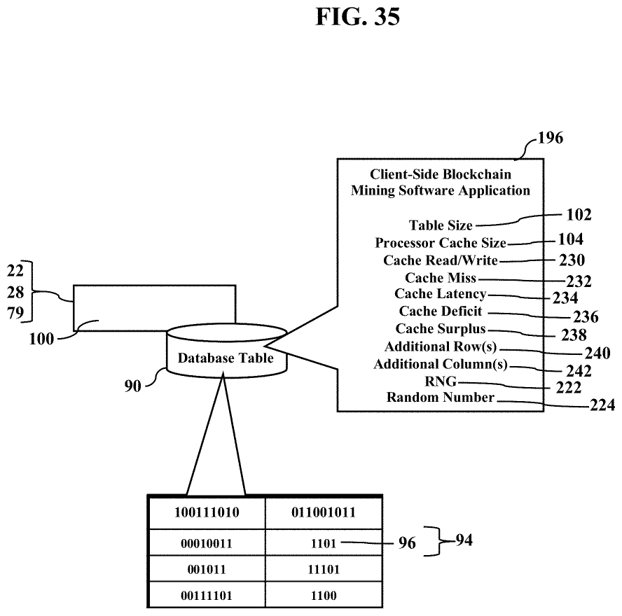

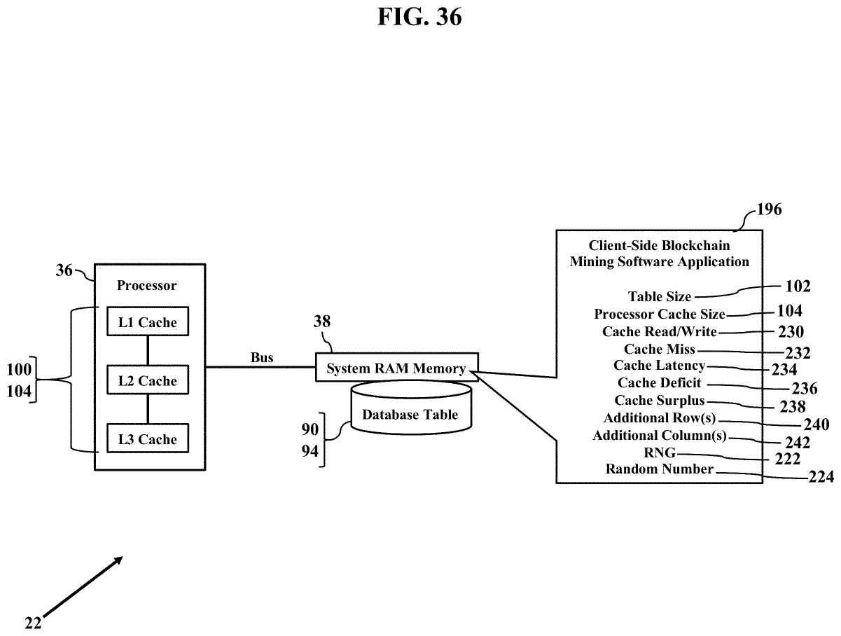

FIGS. 35-36 further illustrate the database table 90, according to exemplary embodiments. Exemplary embodiments may autonomously or automatically adjust the table byte size 102 (in bits/bytes) of the database table 90 to exceed the storage capacity or cache byte size 104 of the on-board processor cache memory 100. The client-side blockchain mining application 196, for example, may query the CPU 36 to determine the storage capacity or cache byte size 104 of the processor cache memory 100. If the table byte size 102 consumed by the database table 90 exceeds the storage capacity or cache byte size 104 of the processor cache memory 100, then perhaps no action or resolution is required. That is, the database table 90 requires more bytes or space than allocated to, or available from, the processor cache memory 100 (integrated/embedded L1, L2, and L3 SRAM/DRAM cache memory). Any cache read/write operation 230 will invalidate, thus forcing the processing component (whether a GPU, ASIC, or the CPU 36) to incur a cache miss 232 and endure the cache latency 234 of requesting and writing blocks of data via the much-slower bus from the system/main memory 38. The processing component (whether a GPU, ASIC, or the CPU 36) stalls, thus negating the use of a faster GPU or ASIC.

Exemplary embodiments may auto-size the database table 90. When the client-side blockchain mining application 196 determines the storage capacity or cache byte size 104 of the processor cache memory 100, the client-side blockchain mining application 196 may compare the storage capacity or cache byte size 104 to the table byte size 102 of the database table 90. The storage capacity or cache byte size 104 of the processor cache memory 100, for example, may be subtracted from the table byte size 102 of the database table 90. If the resulting value (in bits/bytes) is positive (greater than zero), then the database table 90 exceeds the storage capacity or cache byte size 104 of the processor cache memory 100. The client-side blockchain mining application 196 may thus determine a cache deficit 236, ensuring the cache miss 232 and the cache latency 234.

Exemplary embodiments, however, may determine a cache surplus 238. If the resulting value (in bits/bytes) is zero or negative, then the database table 90 is less than the storage capacity or cache byte size 104 of the processor cache memory 100. Whatever the processing component (whether a GPU, ASIC, or the CPU 36), some or even all of the database table 90 could be stored and retrieved from the processor cache memory 100, thus giving an advantage to a faster processing component. The client-side blockchain mining application 196 may thus increase the table byte size 102 of the database table 90. The client-side blockchain mining application 196, for example, may add one (1) or more additional database rows 240 and/or one (1) or more additional database columns 242. The client-side blockchain mining application 196 may increase the table byte size 102 of the database table 90 by adding additional entries 94, with each added entry 94 specifying more random bits 96. As an example, the client-side blockchain mining application 196 may call, use, or execute the random number generator 222 to generate the random number 224 and then add the additional database row(s) 240 and/or additional database column(s) 242 according to the random number 224. Exemplary embodiments may thus continually or periodically monitor the storage capacity or cache byte size 104 of the processor cache memory 100 and the table byte size 102 of the database table 90. The cache surplus 238 may trigger a resizing operation to ensure the database table 90 always exceeds the processor cache memory 100.

The database table 90 may be large. The above examples only illustrated a simple configuration of a few database entries 94. In actual practice, though, the database table 90 may have hundreds, thousands, or even millions of the rows and columns, perhaps producing hundreds, thousands, millions, or even billions of database entries 94. Exemplary embodiments may repeatedly perform the bit shuffle operation 92 to suit any difficulty or proof-of-work strategy or scheme. The proof-of-work target scheme 34, the difficulty algorithm 48, and/or the proof-of-work algorithm 52 may each specify a minimum and/or a maximum number of bit shuffle operations that are performed.

Exemplary embodiments may use the XOR/Shift random number generator (RNG) 222 coupled with the lookup database table 90 of randomized sets of bytes. The database table 90 may have any number of 256 byte tables combined and shuffled into one large byte lookup table. Exemplary embodiments may then index into this large table to translate the state built up while hashing into deterministic but random byte values. Using a 1 GB lookup table results in a RAM Hash PoW algorithm that spends over 90% of its execution time waiting on memory (RAM) than it does computing the hash. This means far less power consumption, and ASIC and GPU resistance. The ideal platform for PoW using a RAM Hash is a Single Board Computer like a Raspberry PI 4 with 2 GB of memory.

Any or all parameters may be specified. The size of the database table 90 may be specified in bits for the index, the seed used to shuffle the lookup table, the number of rounds to shuffle the table, and the size of the resulting hash. Because the LXRHash is parameterized in this way, as computers get faster and larger memory caches, the LXRHash can be set to use 2GB or 16GB or more. The Memory bottleneck to computation is much easier to manage than attempts to find computational algorithms that cannot be executed faster and cheaper with custom hardware, or specialty hardware like GPUs. Very large lookup tables will blow the memory caches on pretty much any processor or computer architecture. The size of the database table 90 can be increased. to counter improvements in memory caching. The number of bytes in the resulting hash can be increased for more security (greater hash space), without significantly more processing time. LXRHash may even be fast by using small lookup tables. ASIC implementations for small tables would be very easy and very fast. LXRHash only uses iterators (for indexing) shifts, binary ANDs and XORs, and random byte lookups. The use case for LXRHash is Proof of Work (PoW), not cryptographic hashing.

The database table 90 may have equal numbers of every byte value, and shuffled deterministically. When hashing, the bytes from the source data are used to build offsets and state that are in turn used to map the next byte of source. In developing this hash, the goal was to produce very randomized hashes as outputs, with a strong avalanche response to any change to any source byte. This is the prime requirement of PoW. Because of the limited time to perform hashing in a blockchain, collision avoidance is important but not critical. More critical is ensuring engineering the output of the hash isn't possible. Exemplary embodiments yield some interesting qualities. For example, the database table 90 may be any size, so making a version that is ASIC resistant is possible by using very big lookup tables. Such tables blow the processor caches on CPUs and GPUs, making the speed of the hash dependent on random access of memory, not processor power. Using 1 GB lookup table, a very fast ASIC improving hashing is limited to about ˜10% of the computational time for the hash. 90% of the time hashing isn't spent on computation but is spent waiting for memory access. At smaller lookup table sizes, where processor caches work, LXRHash can be modified to be very fast. LXRHash would be an easy ASIC design as it only uses counters, decrements, XORs, and shifts. The hash may be altered by changing the size of the lookup table, the seed, size of the hash produced. Change any parameter and you change the space from which hashes are produced. The Microprocessor in most computer systems accounts for 10× the power requirements of memory. If we consider PoW on a device over time, then LXRHash is estimated to reduce power requirements by about a factor of 10.

Testing has revealed some optimizations. LXRHash is comparatively slow by design (to make PoW CPU bound), but quite a number of use cases don't need PoW, but really just need to validate data matches the hash. So using LXRHash as a hashing function isn't as desirable as simply using it as a PoW function. The somewhat obvious conclusion is that in fact we can use Sha256 as the hash function for applications, and only use the LXR approach as a PoW measure. So in this case, what we do is change how we compute the PoW of a hash. So instead of simply looking at the high order bits and saying that the greater the value the greater the difficulty (or the lower the value the lower the difficulty) we instead define an expensive function to calculate the PoW.

Exemplary embodiments may break out PoW measures from cryptographic hashes. The advantage here is that what exactly it means to weigh PoW between miners can be determined apart from the hash that secures a blockchain. Also, a good cryptographic hash provides a much better base from which to randomize PoW even if we are going to use a 1 GB byte map to bound performance by DRAM access. And we could also use past mining, reputation, staking, or other factors to add to PoW at this point.

PoW may be represented as a nice standard sized value. Because exemplary embodiments may use a function to compute the PoW, we can also easily standardize the size of the difficulty. Since bytes that are all 0xFF or all 0x00 are pretty much wasted, we can simply count them and combine that count with the following bytes. This encoding is compact and easily compared to other difficulties in a standard size with plenty of resolution. So with PoW represented as a large number, the bigger the more difficult, the following rules may be followed. Where bit 0 is most significant, and bit 63 is least significant:

Bits 0-3 Count of leading 0xFF bytes; and
Bits 4-63 bits of the following bytes.
   For example, given the hash
   ffffff7312334c442bf42625f7856fe0d50e4aa45c98d7a391c016b89e242d94,
      the difficulty is 37312334c442bf42. The computation counts the leading bytes with a value of 0xFF, then calculates the unit 64 value of the next 8 bytes. The count is combined with the following bytes by shifting the 8 bytes right by 4, and adding the count shifted left by 60. As computing power grows, more significant bits of the hash can be used to represent the difficulty. At a minimum, difficulty is represented by 4 bits 0x0 plus the following 0+60 bits=>60 bits of accuracy. At the maximum, difficulty is represented by 4 bits 0xF plus the following 60 bits=>120+60=180 bits of accuracy.

Sha256 is very well tested as a cryptographic function, with excellent waterfall properties (meaning odds are very close to 50% that any change in the input will flit any particular bit in the resulting hash). Hashing the data being mined by the miners is pretty fast. If an application chooses to use a different hashing function, that's okay as well.

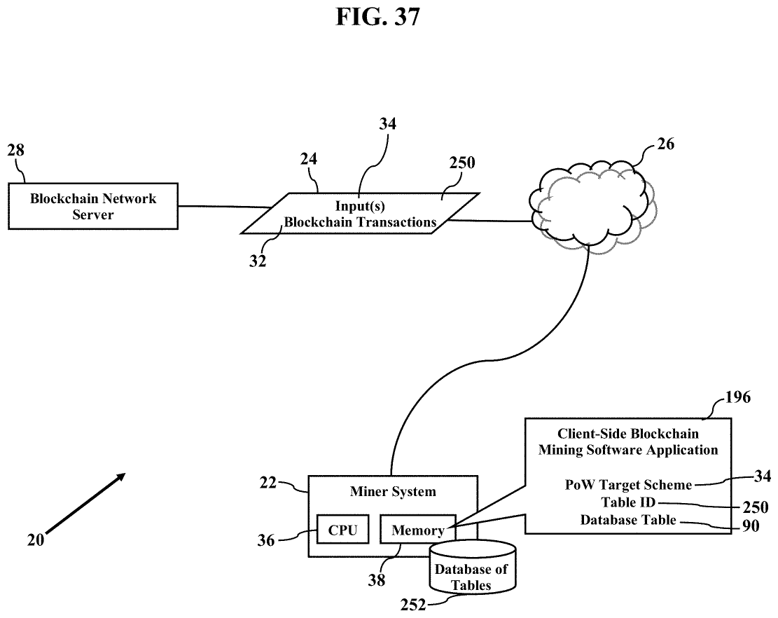

FIGS. 37-40 illustrate a table identifier mechanism, according to exemplary embodiments. When the miner system 22 communicates with the blockchain network server 28, the blockchain network server 28 may specify the proof-of-work (“PoW”) target scheme 34 and/or the database table 90 that is required by the blockchain environment 20. For example, in order to reduce a memory byte size and/or programming line size of the proof-of-work (“PoW”) target scheme 34 and/or the client-side blockchain mining software application 196, exemplary embodiments may only specify a table identifier 250 associated with the blockchain network's chosen or required difficulty and proof-of-work scheme. The table identifier 250 may be any alphanumeric combination, hash value, network address, website, or other data/information that uniquely identifies the database table 90 used by the blockchain environment 20. The blockchain network server 28 may thus send the table identifier 250 (via the communications network 26) to the miner system 22. The table identifier 250 may be packaged as a downloadable component, parameter, or value with the client-side blockchain mining software application 196. However, the table identifier 250 may additionally or alternatively be sent to the miner system 22, such as the packetized message 202 that includes or specifies the table identifier 250 (explained with reference to FIGS. 22-31). Because the table identifier 250 may be separately sent from the client-side blockchain mining software application 196, the table identifier 250 may be dynamically updated or changed without downloading a new or updated client-side blockchain mining software application 196.

Exemplary embodiments may consult an electronic database 252 of tables. When the miner system 22 receives the table identifier 250, the miner system 22 may use, call, and/or implement the database table 90 represented by the table identifier 250. The miner system 22 may obtain, read, or retrieve the table identifier 250 specified by the client-side blockchain mining software application 196. The miner system 22 may additionally or alternatively inspect, read, or retrieve the table identifier 250 from the message 202. Once the table identifier 250 is determined, the miner system 22 may identify the corresponding database table 90 by querying the database 252 of tables for the table identifier 250. FIG. 37 illustrates the electronic database 252 of tables locally stored in the memory device 38 of the miner system 22. The database 252 of tables stores, references, or associates the table identifier 250 and/or the proof-of-work target scheme 34 to the corresponding database table 90. The miner system 22 may thus identify and/or retrieve the database table 90. The miner system 22 may then execute the difficulty algorithm 48 and/or the proof-of-work algorithm using the entries specified by the database table 90 (as this disclosure above explains).

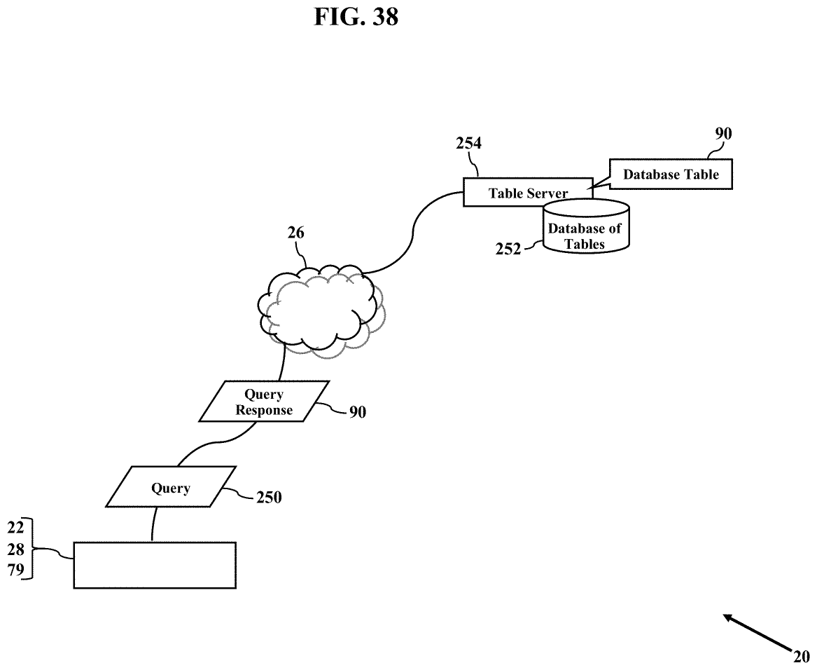

FIG. 38 illustrates remote retrieval. FIG. 38 illustrates the database 252 of tables remotely stored by a table server 254 and accessed via the communications network 26. The table server 254 may be the only authorized source for the database table 90. The table server 254 may thus operate within the blockchain environment 20 and provide the latest/current database table 90 for all miners in the blockchain network. The table server 254, however, may be operated on behalf of an authorized third-party vendor or supplier that provides the database table 90 for all miners in the blockchain network. Once the miner system 22 determines the table identifier 250, the miner system 22 may send a query to the network address associated with or assigned to the table server 254. The query specifies the table identifier 250. When the table server 254 receives the query, the table server 254 queries the electronic database 252 of tables for the table identifier 250 specified by the query. The table server 254 has a hardware processor and memory device (not shown for simplicity) that stores and executes a query handler software application. The query handler software application causes the table server 254 to perform a database lookup operation. The table server 254 identifies the corresponding database table 90 by querying the database 252 of tables for the table identifier 250. The table server 254 generates and sends a query response to the network address associated with or assigned to the miner system 22, and the query response includes or specifies the database table 90 that is associated with the table identifier 250. The miner system 22 may thus identify, download, and/or retrieve the database table 90.

Because the database 252 of tables may store or reference many different database tables, exemplary embodiments may dynamically switch or change the database table 90 to suit any objective or performance criterion. Exemplary embodiments may thus need only specify the table identifier 250, and the table identifier 250 may be dynamically changed at any time. The blockchain environment 20 may flexibly switch, change, and evaluate different database tables, merely by changing or modifying the table identifier 250. The blockchain network may thus experiment with different database tables, different difficulty algorithms 48, and/or different proof-of-work algorithms 52 with little or no impact or effect on hashing. Should an experimental scheme prove or become undesirable, for whatever reason(s), the blockchain environment 20 (such as the blockchain network server 28) may distribute, assign, or restore a new/different table identifier 250 (perhaps by updating the client-side blockchain mining software application 196 and/or distributing/broadcasting the message 202, as this disclosure above explains). The blockchain environment 20 may thus dynamically change the database table 90, which may concomitantly change the difficulty algorithm 48 and/or the proof-of-work algorithm 52, for quick evaluation and/or problem resolution.

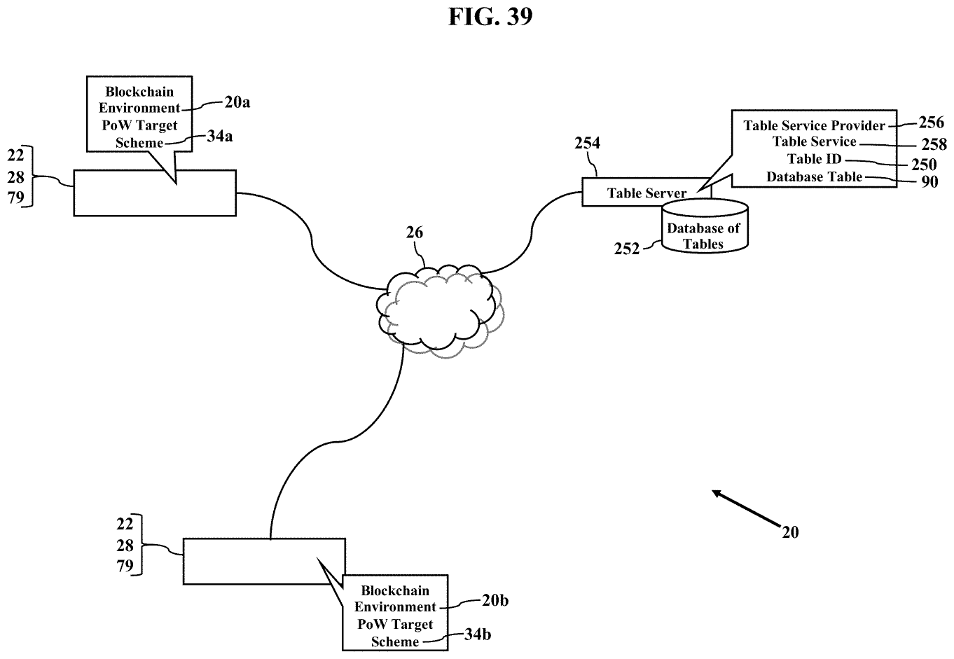

FIG. 39 further illustrates table services. Here the table server 254 may serve different blockchain environments 20. For example, the table server 254 may server miners 22a operating in blockchain environment 20a. The table server 254 may also server miners 22b operating in blockchain environment 20b. The table server 254 may thus be operated on behalf of a table service provider 256 that provides a table service 258 to clients and blockchain networks. The table service provider 256 may receive, generate, and/or store different database tables 90, perhaps according to a client's or a blockchain's specification. Each different table 90 may have its corresponding unique table identifier 250. So, whatever the proof-of-work (“PoW”) target scheme (e.g., 34a and 34b) and/or the blockchain environment 20a-b, the table server 254 may offer and provide the corresponding database table 90. The table service provider 256 and/or the table server 254 may thus be an authorized provider or participant in the blockchain environments 20a-b. A first miner system 22a, for example, operating in the blockchain environment 20a, may request and retrieve the database table 90a that corresponds to the proof-of-work (“PoW”) target scheme 34a. A different, second system 22b, operating in the blockchain environment 20b, may request and retrieve the database table 90b that corresponds to the proof-of-work (“PoW”) target scheme 34b. Miners may query the table server 254 (perhaps by specifying the corresponding table ID 250) and retrieve the corresponding database table 90. The table service provider 256 may thus specialize in randomized/cryptographic database tables, and the table server 254 may serve different blockchain networks.

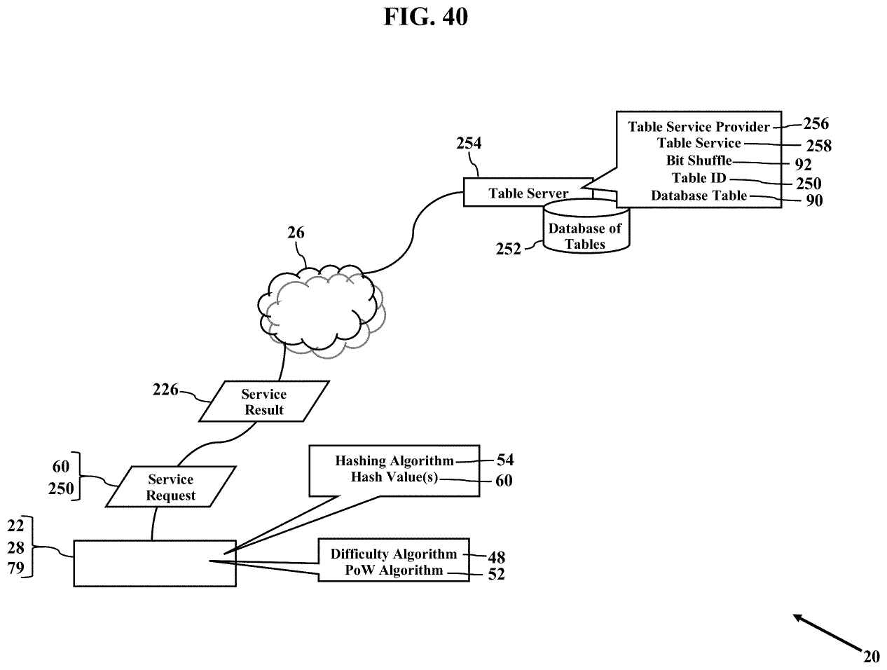

FIG. 40 further illustrates table services. The blockchain environment 20 and/or the miner system 22 may outsource the bit shuffle operation 92 to the table service provider 256. Once the miner system 22 determines or receives the hash value(s) 64 (generated by the hashing algorithm 58), the miner system 22 may outsource or subcontract the bit swap operation 92 to the table server 254. The client-side blockchain mining software application 196 may thus cause or instruct the miner system 22 to generate a bit shuffle service request that is sent to the table service provider 256 (such as the IP address assigned to the table server 254). The bit shuffle service request may specify or include the hash values 64. The bit shuffle service request may additionally or alternatively specify or include the table identifier 250. The bit shuffle service request may additionally or alternatively specify or include a website, webpage, network address location, or server from which the hash values 64 may be downloaded, retrieved, or obtained to perform the bit shuffle operation 92. While the table service provider 256 may utilize any mechanism to provide the bit shuffle operation 92, FIG. 40 illustrates a vendor's server/client relationship. The miner system 22 sends the bit shuffle service request to the table server 254 that is operated on behalf of the table service provider 256. When the table server 254 receives the bit shuffle service request, the table server 254 may query the database 252 of tables for the table identifier 250 specified by the bit shuffle service request. The table server 254 identifies the corresponding database table 90. The table server 254 performs the bit shuffle operation 92 using the hash value(s) 64 specified by, or referenced by, the bit shuffle service request. The table server 254 generates and sends a service result to the network address associated with or assigned to the miner system 22, and the service result includes or specifies data or information representing the randomized hash value(s) 226. The miner system 22 may then execute, or outsource, the difficulty algorithm 48 and/or the proof-of-work algorithm 52 using the randomized hash value(s) 226 (as this disclosure above explained).

Exemplary embodiments improve computer functioning. The database table 90 adds cryptographic security by further randomizing the hash value(s) 64 generated by the hashing algorithm 58. Moreover, because the database table 90 may be remotely located and accessed, exemplary embodiments may only specify the table identifier 250. The memory byte size consumed by the proof-of-work (“PoW”) target scheme 34 and/or the client-side blockchain mining software application 196 is reduced. That is, the blockchain network server 28 need not send the entire software program, code, or instructions representing the database table 90 used by the blockchain environment 20. The blockchain environment 20, the blockchain network server 28, and/or the proof-of-work (“PoW”) target scheme 34 need only specify the much smaller byte-sized table identifier 250. The blockchain environment 20 need not be burdened with conveying the database table 90 to the miner system 22 and to other mining nodes. The blockchain environment 20 and the communication network 26 convey less packet traffic, so packet travel times and network latency are reduced. Moreover, especially if the miner system 22 outsources table operations, the miner system 22 is relieved from processing/executing the bit swap operation 92 and consumes less electrical power. Again, then, a faster and more expensive graphics processor or even ASIC will not speed up the proof-of-work operation. The conventional central processing unit 36 is adequate, reduces costs, and promotes democratic mining.

Exemplary embodiments improve cryptographic security. If the blockchain environment 20, the proof-of-work (“PoW”) target scheme 34 and/or the client-side blockchain mining software application 196 specifies use of the database table 90, only authorized miners may have access to the actual entries referenced by the database table 90. That is, if miner system 22 is required to perform, implement, or even execute the bit shuffle operation 92, the miner system 22 must have access to the correct database table 90. An unauthorized or rogue entity, in other words, likely could not perform the bit shuffle operation 92 without access to the correct database table 90. Moreover, if the bit shuffle operation 92 is remotely performed from the miner system 22 (such as by the table server 254, as above explained), perhaps not even the authorized miner system 22 need have access to the database table 90. So, even if the miner system 22 is authorized to mine or process blockchain transactions 32 in the blockchain environment 20, the authorized miner system 22 may still be blind to the database table 90. The authorized miner system 22, in other words, is operationally reliant on the table server 254 to perform the bit shuffle operation 92 that may be required for the difficulty algorithm 48 and/or for the proof-of-work algorithm 52. The miner system 22 simply cannot solve the mathematical puzzle 54 without the table service 258 provided by the table server 254. The database table 90 may thus be proprietary to the blockchain environment 20, but, unknown and unavailable to even the authorized miner system 22 for added cryptographic security.

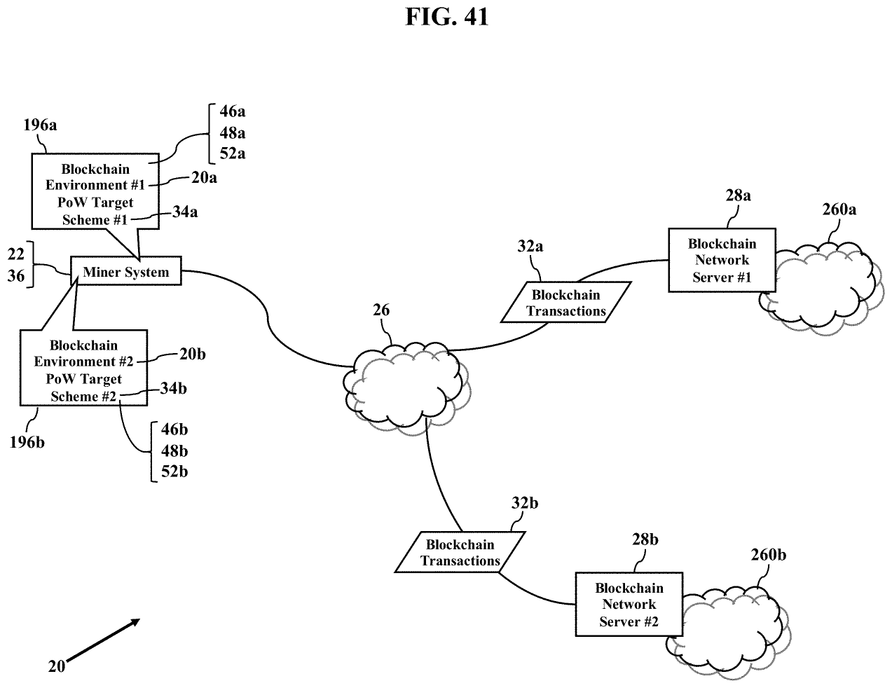

FIG. 41 illustrates agnostic blockchain mining, according to exemplary embodiments. As the reader may now realize, the miner system 22 may be agnostic to the blockchain environment 20. Because the miner system 22 may be agnostic to encryption, difficulty, and proof-of-work operations, the miner system 22 may process or mine the blockchain transactions 32 in multiple blockchain environments 20. That is, because the conventional CPU 36 is adequate for mining blockchain transactions 32, no specialized ASIC is required for any particular blockchain environment 20. The miner system 22 may thus participate in multiple blockchain environments 20 and potentially earn multiple rewards. The miner system 22, for example, may participate in the blockchain environment 22a and mine the blockchain transactions 32a sent from the blockchain network server 28a to authorized miners in blockchain network 260a. The miner system 22 may thus mine the blockchain transactions 32a according to the proof-of-work (“PoW”) target scheme 34a that is specified by the blockchain environment 22a, the blockchain network server 28a, and/or the blockchain network 260a. The miner system 22, however, may also participate in the blockchain environment 22b and mine the blockchain transactions 32b sent from the blockchain network server 28b to authorized miners in blockchain network 260b. The miner system 22 may thus mine the blockchain transactions 32b according to the proof-of-work (“PoW”) target scheme 34b that is specified by the blockchain environment 22b, the blockchain network server 28b, and/or the blockchain network 260b. Because exemplary embodiments require no specialized GPU or ASIC, the miner's conventional CPU 36 may be adequate for mining operations in both blockchain environments 22a and 22b. The miner system 22 may thus download, store, and execute the client-side blockchain mining software application 196a that is required to mine the blockchain transactions 32a in the blockchain environment 20a. The miner system 22 may also download, store, and execute the client-side blockchain mining software application 196b that is required to mine the blockchain transactions 32b in the blockchain environment 20b. The miner system 22 may thus call, execute, coordinate, or manage the encryption algorithm 46a, the difficulty algorithm 48a, and/or the proof-of-work (“PoW”) algorithm 52a according to the proof-of-work (“PoW”) target scheme 34a specified by the blockchain environment 20a. The miner system 22 may also call, execute, coordinate, or manage the encryption algorithm 46b, the difficulty algorithm 48b, and/or the proof-of-work (“PoW”) algorithm 52b according to the proof-of-work (“PoW”) target scheme 34b specified by the blockchain environment 20b. Because exemplary embodiments require no specialized GPU or ASIC, the miner system 22 has the hardware processor capability and performance (e.g., clock speed, processor core(s)/thread(s) count, cycles, the on-board cache memory 100, thermal profile, electrical power consumption, and/or chipset) to mine in both blockchain environments 20a and 20b. The miner system 22 may participate in multiple blockchain environments 20, thus having the capability to earn additional rewards, while also being less expensive to purchase and to operate.

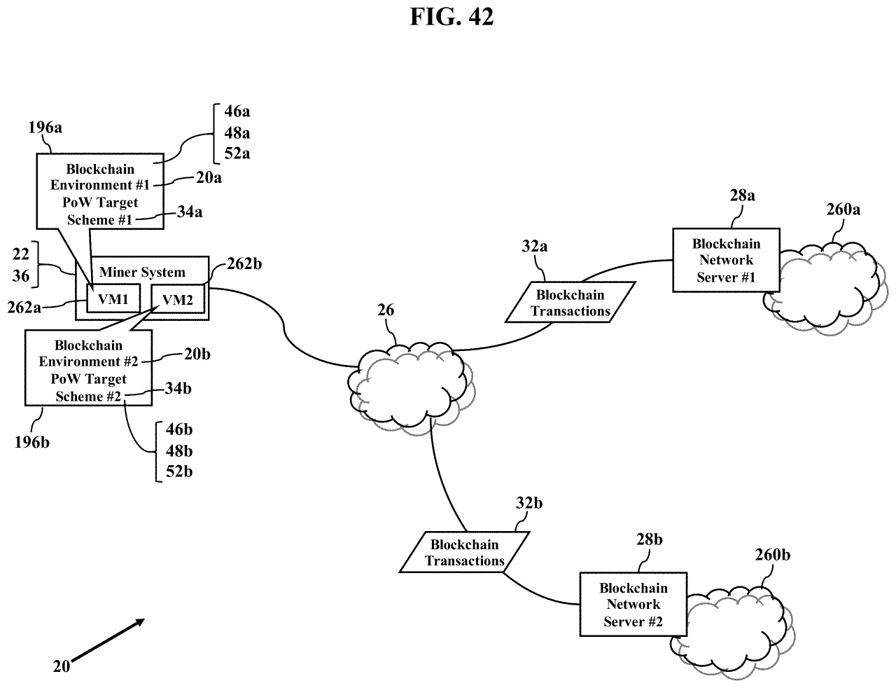

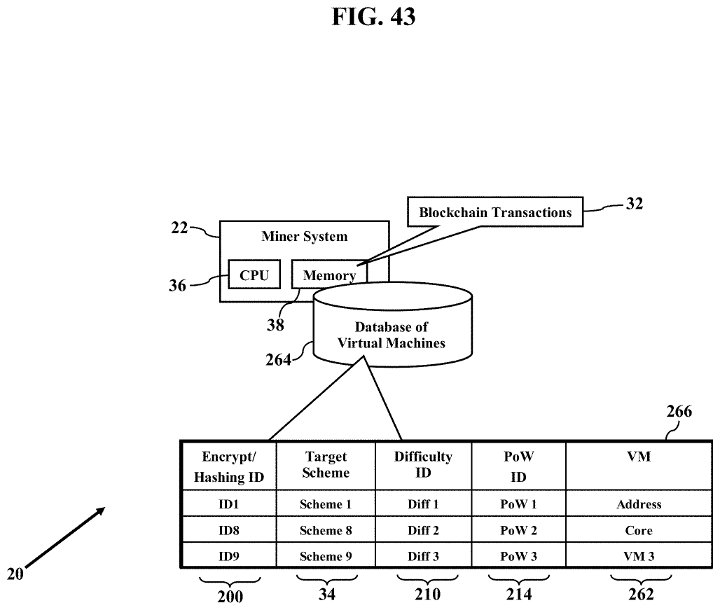

FIGS. 42-43 illustrate virtual blockchain mining, according to exemplary embodiments. Because the miner system 22 may be agnostic to the blockchain environment 20, the miner system 22 may outsource or subcontract mining operations to a virtual machine (or “VM”) 262. For example, the miner system 22 may implement different virtual machines 262, with each virtual machine 262 dedicated to a particular blockchain environment 20. The miner system 22, for example, may assign the virtual machine 262a to mining the blockchain transactions 32a sent from the blockchain network server 28a. The miner system 22 may assign the virtual machine 262b to mining the blockchain transactions 32b sent from the blockchain network server 28b. The miner system 22 may thus be a server computer that participates in multiple blockchain environments 20 and potentially earns multiple rewards. The miner system 22 may provide virtual mining resources to multiple blockchain environments 20, thus lending or sharing its hardware, computing, and programming resources. While FIG. 42 only illustrates two (2) virtual machines 262a and 262b, in practice the miner system 22 may implement any number or instantiations of different virtual machines 262, with each virtual machine 262 serving or mining one or multiple blockchain environments 20. So, when the miner system 22 receives the blockchain transactions 32, the miner system 22 may inspect the blockchain transactions 32 for the proof-of-work (“PoW”) target scheme 34 that identifies the corresponding encryption, difficulty, and PoW scheme (such as by consulting the databases 70, 74, and 78, as above explained). The miner system 22 may additionally or alternatively inspect the blockchain transactions 32 for the identifiers 200, 210, 214, and 250 (as this disclosure above explains). Once the blockchain environment 20 is determined, the miner system 22 may then

FIG. 43 illustrates a database lookup. When the miner system 22 determines the PoW scheme 34 and/or any of the identifiers 200, 210, 214, and 250, the miner system 22 may identify the corresponding virtual machine 262. For example, the miner system 22 may consult an electronic database 264 of virtual machines. While the database 264 of virtual machines may have any structure, FIG. 43 illustrates a relational table 266 having entries that map or associate the PoW scheme 34 and/or any of the identifiers 200, 210, 214, 250 to the corresponding virtual machine 262. The miner system 22 may thus query the electronic database 264 of virtual machines for any of the PoW scheme 34 and/or any of the identifiers 200, 210, 214, 250 and determine the corresponding virtual machine 262. Once the virtual machine 262 is identified (e.g., a memory address or pointer, processor core, identifier, network address and/or service provider, or other indicator), the miner system 22 may assign the blockchain transactions 32 to the virtual machine 262 for mining.

The miner system 22 may thus serve many blockchains. The miner system 22, for example, may mine BITCOIN® and other cryptographic coin transactional records. However, the miner system 22 may also nearly simultaneously mine financial records sent from or associated with a financial institution, inventory/sales/shipping records sent from a retailer, and transactional records sent from an online website. The miner system 22 may participate in multiple blockchain environments 20, thus having the capability to earn additional rewards, while also being less expensive to purchase and to operate.

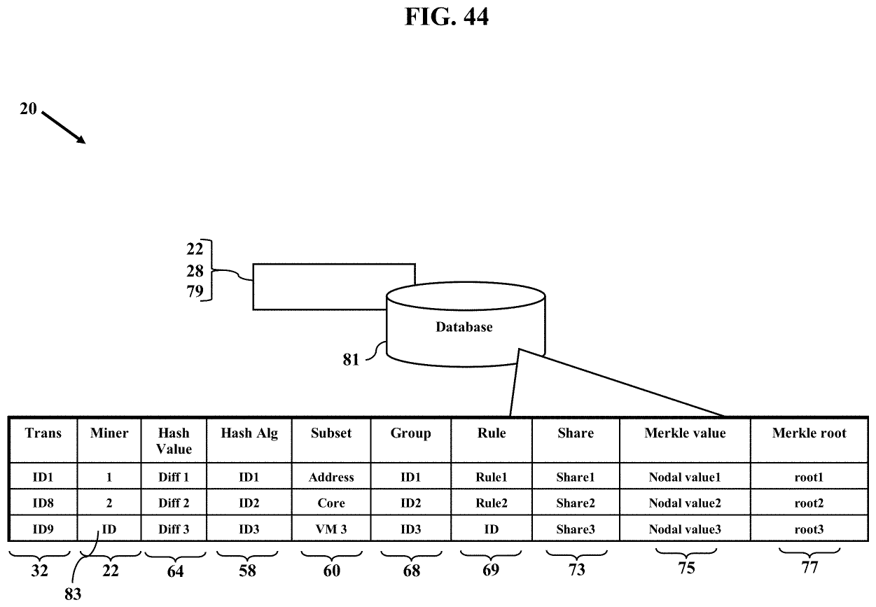

FIG. 44 further illustrates validation monitoring, according to exemplary embodiments. As this disclosure above explained, the miner system 22, the blockchain network server 28, and/or the accumulator device 79 may track the encryptions/validations of the blockchain transactions 32. The miner system 22, the blockchain network server 28, and/or the accumulator device 79 may collect/accumulate the hash values 64 (such as the nodal Merkle values 75 and/or the Merkle root 77) determined by blockchain node machine. As the individual nodal Merkle values 75 are sent or retrieved, the Merkle tree may be constructed. The miner system 22, the blockchain network server 28, and/or the accumulator device 79 may thus store or track each blockchain transaction 32 and its individual or group contribution to any child/node/leaf/branch/nodal Merkle value 75. The miner system 22, the blockchain network server 28, and/or the accumulator device 79 may thus store or access the database 81 and update its entries. While the database 81 may have any logical or programming structure, a relational arrangement is thought easiest to understand. FIG. 44 thus illustrates the database 81 as an electronic table having entries that map, relate, or associate any blockchain transaction 32 to its validating miner system 22, its corresponding hash value 64, and the hashing algorithm 58 used to calculate the hash value 64. The database 81 may further have additional or alternative entries that map the contributory subset 60, group 68, validation rule 69, share 73, Merkle value 76, and/or Merkle root 77. The miner system 22, the blockchain network server 28, and/or the accumulator device 79 may thus query the database 81 for any query parameter. If an entry matches the query parameter, then any of the row/columnar corresponding entries may be identified and/or retrieved. The miner system 22, the blockchain network server 28, and/or the accumulator device 79 may thus easily perform database lookups to identify and retrieve any of the nodal Merkle values 75 associated with encrypting/validating the blockchain transactions 32 and/or the block 40 of data. The miner system 22, the blockchain network server 28, and/or the accumulator device 79 may thus also use the database entries to construct the Merkle tree representing the blockchain transactions 32 and/or the block 40 of data.

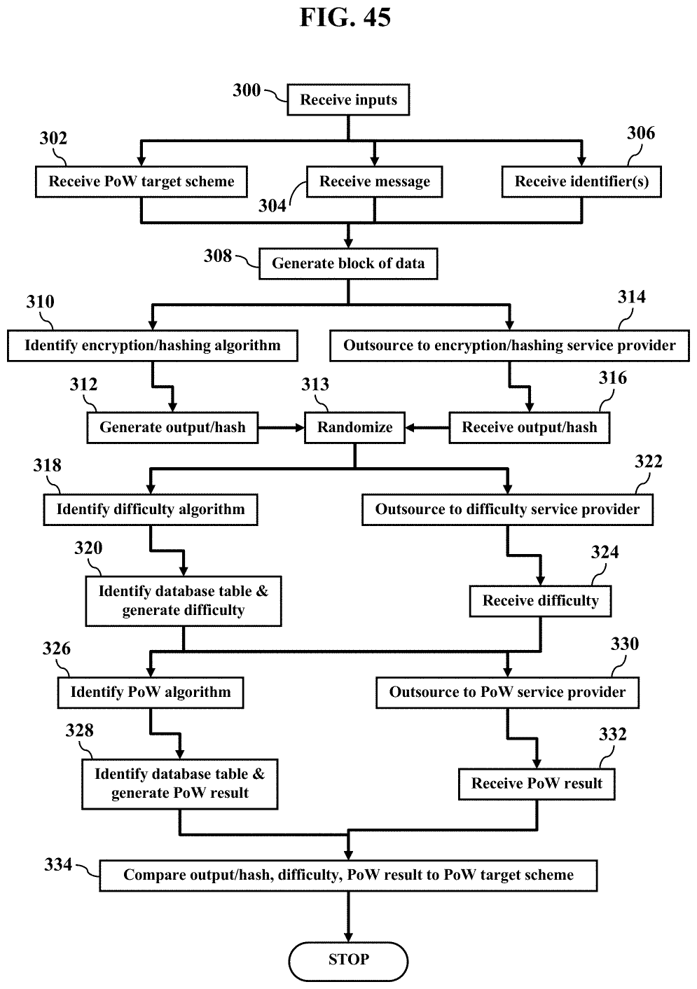

FIG. 45 is a flowchart illustrating a method or algorithm for mining/validating the blockchain transactions 32, according to exemplary embodiments. The inputs 24 (such as the blockchain transactions 32) may be received (Block 300). The proof-of-work (“PoW”) target scheme 34 may be received (Block 302). The message 202 may be received (Block 304). The identifiers 200, 210, 214, and/or 250 may be received (Block 306). The block 40 of data may be generated (Block 308). The encryption algorithm 46 (such as the hashing algorithm 58) may be identified (Block 310) and the output 62 (such as the hash values 64) may be generated by encrypting/hashing the blockchain transactions 32 and/or the block 40 of data (Block 312). The output 62 may be randomized (Block 313) using the bit shuffle operation. The encryption/hashing service provider 150 may be identified and the blockchain transactions 32 and/or the block 40 of data outsourced (Block 314). The output 62 (such as the hash values 64) may be received from the encryption/hashing service provider 150 (Block 316) and randomized (Block 313). The difficulty algorithm 48 may be identified (Block 318), the database table 90 may be generated or identified, and the difficulty 50 may be generated by executing the difficulty algorithm 48 (Block 320). The difficulty service provider 156 may be identified and the difficulty calculation outsourced (Block 322). The difficulty 50 may be received from the difficulty service provider 156 (Block 324). The PoW algorithm 52 may be identified (Block 326), the database table 90 may be generated or identified, and the PoW result 42 determined by executing the PoW algorithm 52 (Block 328). The PoW service provider 120 may be identified and the PoW calculation outsourced (Block 330). The PoW result 42 may be received from the PoW service provider 120 (Block 332). The output 62 (such as the hash values 64), the difficulty 50, and/or the PoW result 42 may be compared to the PoW target scheme 34 (Block 334).

Exemplary embodiments may win the block 40 of data. If the output 62, the difficulty 50, and/or the PoW result 42 satisfy the PoW target scheme 34, then the miner system 22, the blockchain network server 28, and/or the accumulator device 79 may submit the output 62, the difficulty 50, and/or the PoW result 42 to the blockchain network server 28 and/or to the accumulator device 79. The miner system 22 may itself determine if the miner system 22 is the first to satisfy the PoW target scheme 34, or the miner system 22 may rely on the blockchain network server 28 and/or to the accumulator device 79 to determine the first solution. When the miner system 22 is the first solver, the miner system 22 earns the right to add the block 40 of data to the blockchain 56. However, if the PoW target scheme 34 is not satisfied, the miner system 22 implements a change or modification and repeats.

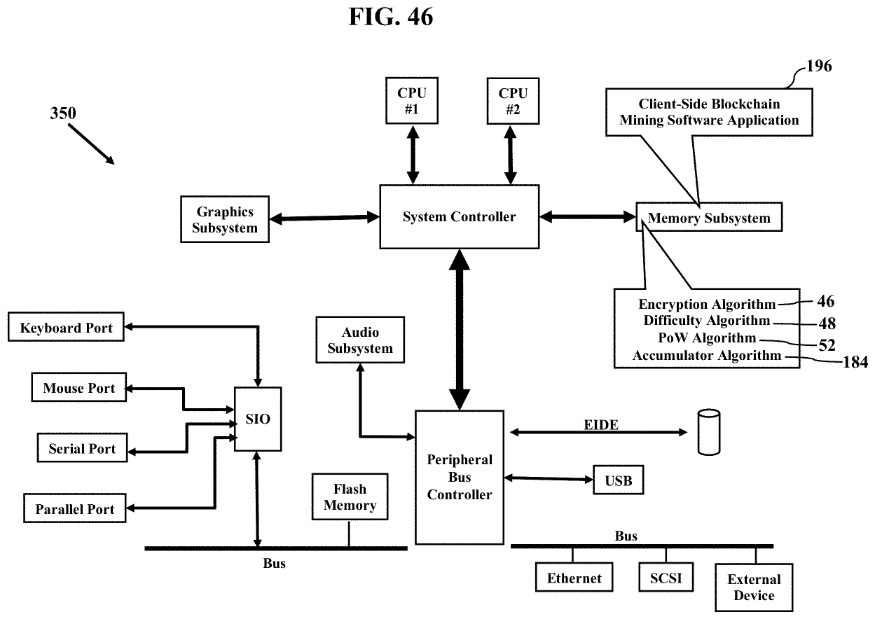

FIG. 46 is a schematic illustrating still more exemplary embodiments. FIG. 46 is a more detailed diagram illustrating a processor-controlled device 350. As earlier paragraphs explained, the miner system 22, the blockchain network server 28, and/or the accumulator device 79 may be any home or business server/desktop computer 85, laptop computer 162, smartphone 87, tablet computer 166, smartwatch 168, or vehicle 170 as exemplary embodiments allow these devices to have adequate processing and memory capabilities to realistically mine and win the block 40 of data. Moreover, exemplary embodiments allow any CPU-controlled device to realistically, and profitably, process the blockchain transactions 32, thus allowing networked appliances, radios/stereos, clocks, tools (such as OBDII diagnostic analyzers and multimeters), HVAC thermostats and equipment, network switches/routers/modems, and electric/battery/ICU engine cars, trucks, airplanes, construction equipment, scooters, and other vehicles 170.

Exemplary embodiments may be applied to any signaling standard. Most readers are familiar with the smartphone 164 and mobile computing. Exemplary embodiments may be applied to any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, low-power or near-field, and any other standard or value.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for processing or mining the blockchain transactions 32, as the above paragraphs explain.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of deterring a specialized hardware processor when validating blockchain transactions in a blockchain environment, comprising:
receiving, by an accumulator device, nodal Merkle values sent as outputs from miner systems validating the blockchain transactions conducted via a computer network in the blockchain environment; and
constructing, by the accumulator device, a Merkle tree using the nodal Merkle values sent as the outputs from the miner systems validating the blockchain transactions conducted via the computer network in the blockchain environment;
wherein the nodal Merkle values sent as the outputs from the miner systems deter the specialized hardware processor in the blockchain environment.

2. The method of claim 1, further comprising assigning a group of the blockchain transactions as inputs to at least one miner system of the miner systems.

3. The method of claim 1, further comprising receiving a nodal Merkle value of the nodal Merkle values representing a hashing of the group of the blockchain transactions.

4. The method of claim 1, further comprising identifying a hashing algorithm specified by the blockchain environment.

5. The method of claim 1, further comprising generating randomized Merkle values by randomizing the nodal Merkle values sent as the outputs from the miner systems.

6. The method of claim 1, further comprising generating randomized Merkle values by swapping bits in the nodal Merkle values sent as the outputs from the miner systems. The method of claim 1, further comprising:
identifying a database entry specifying random bits; and
generating randomized Merkle values by swapping bits in the nodal Merkle values with the random bits identified by the database entry.

8. An accumulator device validating blockchain transactions associated with a blockchain environment, comprising:
a central processing unit; and
a memory device storing instructions that, when executed by the central processing unit, perform operations, comprising:
receiving a nodal Merkle value sent as an output from a miner system hashing a group of the blockchain transactions conducted via a computer network in the blockchain environment;
identifying a hashing database table that is specified by the blockchain environment;
generating a randomized Merkle value by executing a bit shuffle operation that swaps a bit value in the nodal Merkle value with an entry in the hashing database table that is specified by the blockchain environment; and
constructing a Merkle tree using the randomized Merkle value generated by the executing of the bit shuffle operation.

9. The accumulator device of claim 8, wherein the operations further comprise assigning the group of the blockchain transactions as an input to the miner system.

10. The accumulator device of claim 8, wherein the operations further comprise sending the group of the blockchain transactions as an input to the miner system.

11. The accumulator device of claim 8, wherein the operations further comprise identifying a hashing algorithm specified by the blockchain environment.

12. The accumulator device of claim 8, wherein the operations further comprise receiving a table identifier that uniquely identifies the hashing database table.

13. The accumulator device of claim 12, wherein the operations further comprise querying a table database that associates the table identifier to the hashing database table.

14. The accumulator device of claim 8, wherein the operations further comprise distributing the randomized Merkle value within the blockchain environment.

15. A memory device storing instructions that, when executed by a central processing unit, perform operations that validate a blockchain transaction associated with a blockchain environment, the operations comprising:
receiving a nodal Merkle value sent as an output from a miner system hashing the blockchain transaction conducted via a computer network in the blockchain environment;
identifying a hashing database table that is specified by the blockchain environment;
generating a randomized Merkle value by executing a bit shuffle operation that swaps a bit value in the nodal Merkle value with an entry in the hashing database table that is specified by the blockchain environment; and
constructing a Merkle tree using the randomized Merkle value generated by the executing of the bit shuffle operation.

16. The memory device of claim 15, wherein the operations further comprise assigning the blockchain transaction as an input to the miner system.

17. The memory device of claim 15, wherein the operations further comprise sending the blockchain transaction as an input to the miner system.

18. The memory device of claim 15, wherein the operations further comprise identifying a hashing algorithm specified by the blockchain environment.

19. The memory device of claim 15, wherein the operations further comprise receiving a table identifier that uniquely identifies the hashing database table.

20. The accumulator device of claim 19, wherein the operations further comprise querying a table database that associates the table identifier to the hashing database table.
